(19) United States
(12) Patent Application Publication
(10) Pub. No.: US 2025/0280396 A1
(43) Pub. Date: Sep. 4, 2025

(54) SIGNAL TRANSMISSION METHOD AND DEVICE, SIGNAL SENDING NODE, AND SIGNAL RECEIVING NODE

(71) Applicant: VIVO MOBILE COMMUNICATION CO., LTD., Dongguan (CN)

(72) Inventors: Jianzhi LI, Dongguan (CN); Jianming WU, Dongguan (CN); Jian YAO, Dongguan (CN); Dajie JIANG, Dongguan (CN)

(21) Appl. No.: 19/212,604

(22) Filed: May 19, 2025

Related U.S. Application Data
(63) Continuation of application No. PCT/CN2023/132213, filed on Nov. 17, 2023.

(30) Foreign Application Priority Data
Nov. 24, 2022 (CN) 202211486682.2

(51) Int. Cl. H04W 72/044

(52) U.S. Cl. CPC H04W 72/044

(57) ABSTRACT

Provided are a signal transmission method and apparatus, a signal transmit node, and a signal receive node. The signal transmission method includes: configuring, by a signal transmit node, a first signal corresponding to each port based on a Costas array corresponding to each of N ports, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service; and sending, by the signal transmit node, the first signal corresponding to each port on each port.

### CROSS-REFERENCE TO RELATED APPLICATIONS

This application is a continuation of International Patent Application No. PCT/CN2023/132213, filed on Nov. 17, 2023, which claims priority to Chinese Patent Application No. 202211486682.2, filed in China on Nov. 24, 2022, both of which are incorporated herein by reference in their entireties.

### TECHNICAL FIELD

This application pertains to the field of communication technologies, and specifically relates to a signal transmission method and apparatus, a signal transmit node, and a signal receive node.

### BACKGROUND

With development of mobile communication technologies, a future mobile communication system, such as a beyond 5^{th} generation mobile communication (Beyond 5th-Generation, B5G) system or a 6^{th} generation (6^{th} Generation, 6G) communication system, may have a sensing capability in addition to a communication capability. That is, information such as a direction, a distance, and a speed of a target object can be sensed or a target object, an event, an environment, or the like can be detected, tracked, identified, and imaged by sending and receiving a sensing-related signal (for example, a signal related to a sensing service or a signal related to an integrated sensing and communication service).

### SUMMARY

Embodiments of this application provide a signal transmission method and apparatus, a signal transmit node, and a signal receive node.

According to a first aspect, a signal transmission method is provided, and the method includes:
configuring, by a signal transmit node, a first signal corresponding to each port based on a Costas (Costas) array corresponding to each of N ports, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service; and
sending, by the signal transmit node, the first signal corresponding to each port on each port.

According to a second aspect, a signal transmission apparatus is provided, applied to a signal receive node, and the apparatus includes:
a configuration module, configured to configure a first signal corresponding to each port based on a Costas array corresponding to each of N ports, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service; and
a first sending module, configured to send the first signal corresponding to each port on each port.

According to a third aspect, a signal transmission method is provided, and the method includes:
receiving, by a signal receive node based on a Costas array corresponding to each of N ports of a signal transmit node, a first signal sent by each port, where
the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service.

According to a fourth aspect, a signal transmission apparatus is provided, applied to a signal receive node, and the apparatus includes:
a first receiving module, configured to receive, based on a Costas array corresponding to each of N ports of a signal transmit node, a first signal sent by each port, where
the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service.

According to a fifth aspect, a signal transmit node is provided. The signal transmit node includes a processor and a memory, the memory stores a program or an instruction that can be run on the processor, and the program or the instruction is executed by the processor to implement the steps of the method according to the first aspect.

According to a sixth aspect, a signal transmit node is provided, including a processor and a communication interface. The processor is configured to configure a first signal corresponding to each port based on a Costas array corresponding to each of N ports, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service; and the communication interface is configured to send the first signal corresponding to each port on each port.

According to a seventh aspect, a signal receive node is provided. The signal receive node includes a processor and a memory, the memory stores a program or an instruction that can be run on the processor, and the program or the instruction is executed by the processor to implement the steps of the method according to the third aspect.

According to an eighth aspect, a signal receive node is provided, including a processor and a communication interface. The communication interface is configured to receive, based on a Costas array corresponding to each of N ports of a signal transmit node, a first signal sent by each port, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service.

According to a ninth aspect, a signal transmission system is provided, including a signal transmit node and a signal receive node. The signal transmit node may be configured to execute the steps of the signal transmission method according to the first aspect, and the signal receive node may be configured to execute the steps of the signal transmission method according to the third aspect.

According to a tenth aspect, a readable storage medium is provided. The readable storage medium stores a program or an instruction, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction to implement the steps of the method according to the first aspect or the steps of the method according to the third aspect.

According to a twelfth aspect, a computer program/program product is provided. The computer program/program product is stored in a storage medium, and the computer program/program product is executed by at least one processor to implement the steps of the method according to the first aspect or the steps of the method according to the third aspect.

### BRIEF DESCRIPTION OF DRAWINGS

FIG. 1 is a block diagram of a wireless communication system to which the embodiments of this application are applicable;

FIG. 2 is a schematic diagram of a CSI-RS time-frequency resource RRC configuration according to an embodiment of this application;

FIG. 3 is a schematic diagram of a CSI-RS physical resource configuration according to an embodiment of this application;

FIG. 4 is a schematic diagram of a periodic CSI-RS slot resource configuration according to an embodiment of this application;

FIG. 5a is a flowchart of a periodic CSI-RS signal configuration according to an embodiment of this application;

FIG. 5b is a flowchart of an aperiodic CSI-RS signal configuration according to an embodiment of this application;

FIG. 6a is a schematic diagram of a plurality of types of CSI-RS CDM according to an embodiment of this application;

FIG. 6b is a schematic diagram of an fd-CDM2 orthogonal code according to an embodiment of this application;

FIG. 7 is a flowchart of a signal transmission method according to an embodiment of this application;

FIG. 8a is a first schematic diagram of a time-frequency resource of a multi-port Costas signal configured based on a No CDM CSI-RS according to an embodiment of this application;

FIG. 8b is a second schematic diagram of a time-frequency resource of a multi-port Costas signal configured based on a No CDM CSI-RS according to an embodiment of this application;

FIG. 9 is a third schematic diagram of a time-frequency resource of a multi-port Costas signal configured based on a No CDM CSI-RS according to an embodiment of this application;

FIG. 10 is a schematic diagram of a mapping unit of a 2-port Costas signal configured based on a CDM CSI-RS according to an embodiment of this application;

FIG. 11a is a first schematic diagram of a time-frequency resource of a multi-port Costas signal configured based on a CDM CSI-RS according to an embodiment of this application;

FIG. 11b is a second schematic diagram of a time-frequency resource of a multi-port Costas signal configured based on a CDM CSI-RS according to an embodiment of this application;

FIG. 12 is a schematic diagram of a mapping unit of a 4-port Costas signal configured based on a CDM CSI-RS according to an embodiment of this application;

FIG. 13 is a flowchart of another signal transmission method according to an embodiment of this application;

FIG. 14 is a structural diagram of a signal transmission apparatus according to an embodiment of this application;

FIG. 15 is a structural diagram of another signal transmission apparatus according to an embodiment of this application;

FIG. 16 is a structural diagram of a communication device according to an embodiment of this application;

FIG. 17 is a structural diagram of a signal transmit node according to an embodiment of this application; and

FIG. 18 is a structural diagram of a signal receive node according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (Long Time Evolution, LTE)/LTE-Advanced (LTE-Advanced, LTE-A) system, and may further be applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (New Radio, NR) system for example purposes, and NR terms are used in most of the following descriptions. These technologies can also be applied to applications other than an NR system application, such as a 6th generation (6th Generation, 6G) communication system.

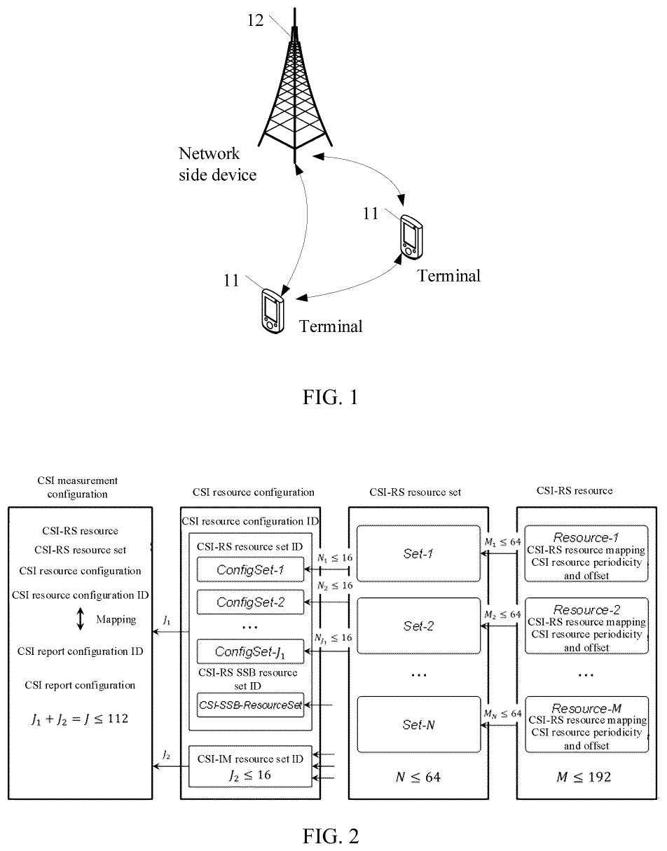

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), a smart home (a home device with a wireless communication function, such as a refrigerator, a television, a washing machine, or a furniture), a game console, a personal computer (personal computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (Radio Access Network, RAN), a radio access network function, or a radio access network unit. The access network device may include a base station, a WLAN access point, a Wi-Fi node, or the like. The base station may be referred to as a NodeB, an evolved NodeB (Evolved NodeB, eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmission Reception Point, TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rule function unit (Policy and Charging Rules Function, PCRF), an edge application server discovery function (Edge Application Server Discovery Function, EASDF), unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF, or L-NEF), a binding support function (Binding Support Function, BSF), an application function (Application Function, AF), and the like. It should be noted that, in the embodiments of this application, only a core network device in an NR system is used as an example for description, and a specific type of the core network device is not limited.

For ease of understanding, the following describes some content in the embodiments of this application.

### 1. Integrated Sensing and Communication

Wireless communication and radar sensing (Communication&Sensing, C&S) have been developing in parallel with limited intersection. They have many commonalities in terms of signal processing algorithms, devices, and system architectures to some extent. In recent years, traditional radar is developing towards more general wireless sensing. Wireless sensing may broadly refer to retrieving information from received radio signals. For wireless sensing related to sensing of a target location, a common signal processing method may be employed to estimate dynamic parameters such as a reflection delay, an angle of arrival, an angle of departure, and Doppler of a target signal. For sensing a target physical feature, this may be achieved by measuring an inherent signal pattern of a device/object/activity. The two sensing manners may be respectively referred to as sensing parameter estimation and pattern recognition. In this sense, wireless sensing refers to more general sensing techniques and applications using radio signals.

Integrated sensing and communication (Integrated Sensing and Communication, ISAC) has a potential to integrate wireless sensing into a mobile network, which is referred to as a perceptive mobile network (Perceptive Mobile Networks, PMNs) herein. For details, refer to a related technology 1 (“Enabling joint communication and radio sensing in mobile networks-a survey” arXiv preprint arXiv: 2006.07559 (2020)). The perceptive mobile network can provide both communication and wireless sensing services and are expected to become a pervasive wireless sensing solution due to large broadband coverage and strong infrastructure. The perceptive mobile network can be widely used in communication and sensing in areas of transportation, communication, energy, precision agriculture, and safety, and also provides complementary sensing capabilities for existing sensor networks, featuring unique day-and-night operational functions that enable it to penetrate fog, leaves, and even solid objects. Some common sensing services are shown in the following Table 1.

TABLE 1
Classification of common sensing services

| | Real-time | | |
|---|---|---|---|
| Physical | sensing | | |
| sensing range | requirement | Sensing function | Application use |
| Large | Medium | Weather, air quality, and | Meteorology, |
| | | the like | agriculture, and life |
| | | | services |
| Large | Medium | Traffic flow (road) and | Smart city, intelligent |
| | | human flow (subway | transportation, and |
| | | station) | business services |
| Large | Medium | Animal activities, | Animal husbandry, |
| | | migration, and the like | ecological environment |
| | | | protection, and the like |
| Large | High | Target tracing, distance | Many application |
| | | measurement, speed | scenarios of traditional |
| | | measurement, and angle | radar, vehicle to |
| | | measurement | everything (Vehicle to |
| | | | Everything, V2X), and |
| | | | the like |
| Large | Low | Three-dimensional map | Navigation and smart |
| | | construction | city |
| Small | High | Action posture recognition | Intelligent interaction |
| | | | of smartphones, games, |
| | | | and smart home |
| Small | High | Heartbeat/breathing and | Health monitoring and |
| | | the like | medical care |
| Small | Medium | Imaging | Security inspection and |
| | | | logistics |
| Small | Low | Material | Construction, |
| | | | manufacturing, |
| | | | exploration, and the like |

### 2. Radar Signal Design and Costas (Costas) Array

A range resolution and a velocity (radial) resolution of a radar depend on a signal waveform selected by the radar. A radar signal occupying a wider bandwidth in frequency domain has a better range resolution, and a radar signal with a larger duration width in time domain has a better velocity resolution. From the perspective of enhancing a radar resolution, the design of radar signals requires that a main peak of a signal ambiguity function be high and sharp, while a secondary peak be low and flat. Common radar signals such as linear frequency modulation (Linear Frequency Modulation, LFM) signals experience coupling between a Doppler frequency shift and a range. When a Doppler frequency shift of a target echo is relatively large, a substantial ranging error is caused. A sidelobe level of an autocorrelation function of a non-linear frequency modulation (Non LFM, NLFM) signal is improved, but the ambiguity function still has a sidelobe with a large range at a high Doppler frequency cross-section, and a sidelobe from a large target or clutter may mask a main lobe of a nearby small target. In a multi-target environment, aggregation of sidelobes of a plurality of target responses may even mask a main lobe of a stronger target response.

The design of sensing/integrated sensing and communication signals is a key focus in the research of an integrated sensing and communication technology, and its design concept can draw on the design of radar signals. The design of radar signals typically requires signals to have a large time-bandwidth product, a constant envelope, and an excellent autocorrelation. For a multiple-input multiple-output (Multiple-Input Multiple-Output, MIMO) radar, additional requirements include good orthogonality between signals of antenna ports.

Costas array:

Let P be an n-order permutation matrix, where the array (horizontal axis) represents time, and the row (vertical axis) represents frequency. A sequence (frequency hopping signal sequence) corresponding to a row index of a matrix element “1” is also referred to as a sequence P. If a maximum value of sidelobes of a (discrete) autocorrelation function of the sequence P is not greater than 1, the permutation matrix P is referred to as an n-order Costas array (Costas Array), and the sequence P is referred to as a Costas sequence. Generally, {c₁, c₂, . . . , cₙ} is used to represent the sequence P. In this application, the Costas array and the Costas sequence may be equivalent, except that names are different, that is, the Costas array and the Costas sequence represent a same object. It should be noted that the array is named from the perspective of a time-frequency two-dimensional resource grid, and the sequence is named from the perspective of a signal, but the two represent a same object. A special sequence structure of the Costas sequence results in theoretically optimal ambiguity function performance, that is, a “thumbtack-shaped” ambiguity function. For details, refer to the related technology 2 (“A study of a class of detection waveforms having nearly ideal range-Doppler ambiguity properties.” Proceedings of the IEEE 72.8 (1984): 996-1009).

The number of n-order Costas arrays is finite. The Costas array may be quickly constructed by using a finite field theory. It should be noted that, in an abstract algebra, a field is a set (an algebraic structure) on which addition, subtraction, multiplication, and division operations may be performed without results exceeding itself, and the concept generalizes number fields and the four operations. If a field F includes only a finite number of elements, the field F is referred to as a finite field and is also referred to as a Galois Field (Galois Field, GF).

### (1) Welch-Costas Array

Set a finite field GF(1), where 1 is a prime, a is a primitive element (Primitive Element) of GF(1), η is a non-zero element (Non-zero Element) of GF(1), that is, a non-zero element. If the sequence P is an (l-1)-order permutation matrix, a sufficient condition for the sequence P to be a Costas sequence is that a placement function of the sequence P is:

$$y ( k ) ≡ {ηα}^{k} ( mod l ) , 1 \leq k \leq l - 1 \qquad ( 1 )$$

This type of array is called a Welch-Costas array. The Welch-Costas sequence is cycled in the horizontal direction with l-1 and is cycled in the vertical direction with l. It may be considered that the sequence represented by equation (1) is obtained by cyclically shifting a sequence represented by equation (2) in the horizontal direction:

$$y ( k ) ≡ {α}^{k} ( mod l ) , 1 \leq k \leq l - 1 \qquad ( 2 )$$

That is, η is 1. Welch-Costas constructed by equation (2) is also referred to as an exponential (Exponential) Welch-Costas array. An inverse function of equation (2) is defined as follows:

$$y ( k ) ≡ {log}_{α} k ( mod l - 1 ) , 0 \leq k \leq l - 1 \qquad ( 3 )$$

It may be understood that the Costas array may also be constructed by using equation (3), and Welch-Costas obtained herein is also referred to as a logarithmic (Logarithmic) Welch-Costas array.

### (2) Golomb-Costas Array

Set a finite field GF(q), where q=l^{m}, 1 is a prime number, and m is a positive integer. a and B are primitive elements of GF(q), and a sufficient condition for the sequence P to be a Golomb-Costas sequence is that a placement function of the sequence P is:

$$y ( k ) ≡ {log}_{β} ( 1 - {α}^{k} ) ( mod f ( x ) ) , 0 \leq k \leq q - 2 \qquad ( 4 )$$

f(x) is any irreducible polynomial of degree m over a congruence class field Zₗ of an integer modulo 1. For details, refer to the related technology 3 (“Application Research of Costas Sequence in Radar Signal Design” Electronics Engineer 33.5 (2007): 1-6) and the related technology 4 (“Constructions and properties of Costas arrays” Proceedings of the IEEE 72.9 (1984): 1143-1163). That is, if coordinates of a cell of the sequence P are (i, j), when αⁱ+β^{j}≡1(mod f(x)), “1” is placed in the cell. The Costas array of this structure is referred to as a Golomb-Costas array.

(3) Lempel-Costas Array

If α=β, an array obtained through equation (5) is a Lempel-Costas array:

$$y ( k ) ≡ {log}_{α} ( 1 - {α}^{k} ) ( mod f ( x ) ) , 0 \leq k \leq q - 2 \qquad ( 5 )$$

It should be noted that for a primitive element, an order of a in a module n is m=phi (n), where a is a primitive element of n, and the primitive element is not unique. For example, primitive elements of GF(19) are 2, 3, and 10, and primitive elements of GF(13) are 2, 6, 7, and 11. For an order, the number of elements in a finite field is referred to as an order of a finite field. For an Euler function, phi(x) is an Euler function, and its value is the number of non-zero positive integers that are less than n and that are coprime to n, for example, phi(8)=4 (1, 3, 5, 7). If n is a prime number, phi(n)=n−1. For example, phi(7)=6 (1, 2, 3, 4, 5, 6).

For example, n=7, 3 is a primitive element of a finite field GF(7), and phi(7)=7−1=6 because 7 is a prime number; and an order of 3 in a module 7 is 6. Specifically, 3⁰mod7=1, 3¹mod7=3, 3²mod7=2, 3³mod7=6, 3⁴mod7=4, 3⁵mod7=5, 3⁶mod7=1, 3⁷mod7=3, and . . . , where a cycle length is 6.

The Costas array may also be obtained through a geometric construction method. A directed line segment connecting two cells “1” of the permutation sequence P is referred to as a vector of the sequence P. Obviously, the sequence P has a total of n(n−1)/2 vectors. If any two vectors of P are different, that is, when directions and/or lengths of the two vectors are different (the same direction herein means that the two vectors are parallel), the sequence P is a Costas sequence. For details, refer to the foregoing related technology 3.

The Costas array may also be obtained through search in an exhaustive manner. That is, a Costas sequence is searched from n! n-order permutation matrices. In the search method, a check matrix (Check Matrix) of the permutation matrix may be computed. To reduce a computational workload, calculation may be simplified by using a property of the check matrix. When n>25, the number of Costas sequences will be significantly reduced. In particular, when n tends to infinity, the number of Costas sequences tends to 0. A specific condition under which no Costas sequence exists is still not determined, but when n=32, 33 or 43, no Costas sequence exists. Table 2 provides 17 Costas arrays with an order n=6, where each row corresponds to one Costas sequence, there are 17 rows in total, and the number of elements in each row is 6.

TABLE 2
Fundamental 6-order Costas arrays for sensing/integrated
sensing and communication signals

| | |
|---|---|
| Index | Fundamental 6-order Costas array set |

| | | | | | | |
|---|---|---|---|---|---|---|
| 0 | 0 | 1 | 4 | 3 | 5 | 2 |
| 1 | 0 | 2 | 1 | 4 | 5 | 3 |
| 2 | 0 | 2 | 5 | 3 | 4 | 1 |
| 3 | 0 | 3 | 2 | 4 | 5 | 1 |
| 4 | 0 | 3 | 4 | 2 | 1 | 5 |
| 5 | 0 | 3 | 5 | 4 | 1 | 2 |
| 6 | 0 | 4 | 2 | 3 | 5 | 1 |
| 7 | 0 | 4 | 2 | 5 | 1 | 3 |
| 8 | 0 | 4 | 3 | 5 | 1 | 2 |
| 9 | 0 | 5 | 2 | 4 | 3 | 1 |
| 10 | 0 | 5 | 3 | 2 | 4 | 1 |
| 11 | 1 | 2 | 5 | 0 | 4 | 3 |
| 12 | 1 | 3 | 0 | 5 | 4 | 2 |
| 13 | 1 | 3 | 2 | 5 | 0 | 4 |
| 14 | 1 | 3 | 4 | 0 | 5 | 2 |
| 15 | 1 | 4 | 0 | 5 | 2 | 3 |
| 16 | 1 | 4 | 0 | 5 | 3 | 2 |

It should be noted that there are five symmetric arrays in the foregoing listed arrays, and a total of 116 Costas arrays in the order are included, which may be obtained by rotating/flipping the fundamental Costas arrays listed in Table 2.

It should be noted that other three different Costas arrays are obtained by performing horizontal flipping, vertical flipping, and simultaneous horizontal and vertical flipping on one Costas array. Further, if an original Costas array is not symmetrical with respect to a diagonal/anti-diagonal, four additional Costas arrays may be obtained through clockwise/counterclockwise rotation and in combination with the aforementioned flipping. In other words, after one Costas array is constructed, four or eight Costas arrays are actually obtained. There are five symmetric arrays in the 6-order Costas arrays shown in Table 2. Therefore, a total of 12×8+5×4 =116 6-order Costas arrays are actually obtained.

TABLE 3
Example of four 17-order Costas arrays with a low cross-correlation

| | | | | | | | | | | | | | | | | |
|---|---|---|---|---|---|---|---|---|---|---|---|---|---|---|---|---|
| 2 | 1 | 15 | 7 | 5 | 11 | 4 | 16 | 13 | 17 | 6 | 14 | 9 | 12 | 3 | 8 | 10 |
| 5 | 17 | 3 | 1 | 4 | 14 | 10 | 7 | 13 | 12 | 2 | 11 | 6 | 8 | 15 | 16 | 9 |
| 13 | 1 | 15 | 17 | 14 | 4 | 8 | 11 | 5 | 6 | 16 | 7 | 12 | 10 | 3 | 2 | 9 |
| 12 | 16 | 11 | 3 | 13 | 10 | 9 | 15 | 17 | 5 | 1 | 6 | 14 | 4 | 7 | 8 | 2 |

Any n-order Costas array has an ideal autocorrelation characteristic, but different Costas arrays of a same order do not necessarily have a relatively low cross-correlation (corresponding to better orthogonality). Table 3 gives four 17-order Costas arrays with a relatively low cross-correlation between any two pairs. A total number of 17-order Costas arrays is 18276. Costas arrays that satisfy a low cross-correlation between any two pairs need to be searched by using optimization algorithms such as a genetic algorithm and a simulated annealing algorithm. In addition, one gap row is added to the Welch-Costas array or the Golomb-Costas array, or one gap row and one gap column are added to the Welch-Costas array or the Golomb-Costas array to construct a family of Costas array sets with a good cross-correlation. Any pairwise combination in this family exhibit an extremely low cross-correlation within specific ranges of time delay and Doppler shift.

### 3. Specific Configuration of CSI-RS Signal Resources

This part is used to illustrate how NR configures a channel state information reference signal (Channel State Information Reference Signal, CSI-RS) by using radio resource control (Radio Resource Control, RRC) signaling. Although configuration of other reference signals is different from that of the CSI-RS, configuration methods are basically the same. This part can be emulated by following the illustration provided, and thus details will not be elaborated on one by one herein.

It should be noted that when a CSI-RS is configured, a network side needs to first consider a preconfigured (Pre-configuration) system signal and a pre-scheduled system channel in an NR system, such as a synchronization signal block (Synchronization Signal Block, SSB). The SSB includes a primary synchronization signal (Primary Synchronization Signal, PSS) and a secondary synchronization signal (Secondary Synchronization Signal, SSS), a physical broadcast channel (Physical Broadcast Channel, PBCH), and a PBCH demodulation reference signal (Demodulation Reference Signal, DMRS). Therefore, configured reference signal resources cannot overlap with resources used by these system signals and system channels.

The CSI-RS signal is configured by an RRC information element (Information Elements, IE), that is, a CSI measurement configuration (CSI-MeasConfig). CSI-MeasConfig includes the following information elements: a CSI-RS resource (NZP-CSI-RS-Resource), a CSI-RS resource set (NZP-CSI-RS-ResourceSet), and a CSI-RS resource configuration (CSI-ResourceConfig).

As shown in FIG. 2, the information element NZP-CSI-RS-Resource is used to configure a CSI-RS physical resource, that is, a mapping relationship (Resource Mapping) between a CSI-RS signal and a resource element (Resource Element, RE) allocated in orthogonal frequency division multiplexing (Orthogonal Frequency Division Multiplexing, OFDM) time-frequency domain. A resource pool configured for the CSI-RS physical resource may have a maximum of 192 different physical resources, that is, M=192. Each CSI-RS physical resource has its own corresponding identifier (ID).

The configured CSI-RS physical resources form a CSI-RS resource set (Resource Set) by using the information element CSI-RS-ResourceSet. A total number of resource sets can be up to 64, that is N=64, and each CSI-RS resource set has its own corresponding ID. Each CSI-RS resource set is selected from the CSI-RS physical resource pool, and each resource set may have a maximum of 64 different physical resources, that is Mₙ=64, where n is an index of a resource set, and 0≤n≤N.

The information element CSI-ResourceConfig is used to configure a CSI-RS resource configuration set. A total number of CSI-RS resource configuration sets J₁ and other resource configuration sets (one SSB resource configuration set and IM resource configuration sets J₂) may reach 112 at most, that is, J₁+J₂=J≤112. The CSI-RS resource configuration set is selected from a CSI-RS resource set. Each CSI-RS resource configuration set may have a maximum of 16 different CSI-RS resource sets, that is, N₁=16, where 0≤1≤J₁. Each CSI-RS resource configuration set has its own corresponding ID. In addition, CSI-ResourceConfig specifies which CSI-ResourceConfig to use for measurement. A measurement type and a corresponding CSI-ResourceConfig ID are completed by using a mapping table.

Specifically, for a CSI-RS time-frequency domain resource, a time-frequency domain resource in each slot (Slot) and a CSI transmission time sequence in the slot are separately configured by using RRC parameters: CSI-RS resource mapping (CSI-RS-ResourceMapping), and resource a CSI periodicity and offset (CSI-ResourcePeriodicityAndOffset) in the information element NZP-CSI-RS-Resource.

More specifically, in each slot, a CSI-RS physical resource is implemented by using the information element CSI-RS-ResourceMapping. The information element CSI-RS-ResourceMapping is mainly used to configure the following resource parameters:

Frequency domain configuration (frequencyDomainAllocation): An OFDM frequency domain resource location is implemented through bit mapping (Bit Mapping), and may indicate any one of 12 REs based on a density of a resource in a resource block (Resource Block, RB). An index of the first RE occupied herein is k₀.

First OFDM symbol in time domain (firstOFDMSymbolInTimeDomain): A time domain location of the first OFDM symbol in each RB may indicate any one of 14 OFDM symbols. An index of the first OFDM symbol occupied herein is I₀.

Code division multiplexing (Code Division Multiplexing, CDM) type (cdm-Type): A code division multiplexing type is noCDM or CDM. A resource of the CDM resource type is designed for a MIMO reference signal.

Density (density): A density of a CSI-RS in frequency domain may be 3, 1, or 0.5, and is represented by a parameter ρ.

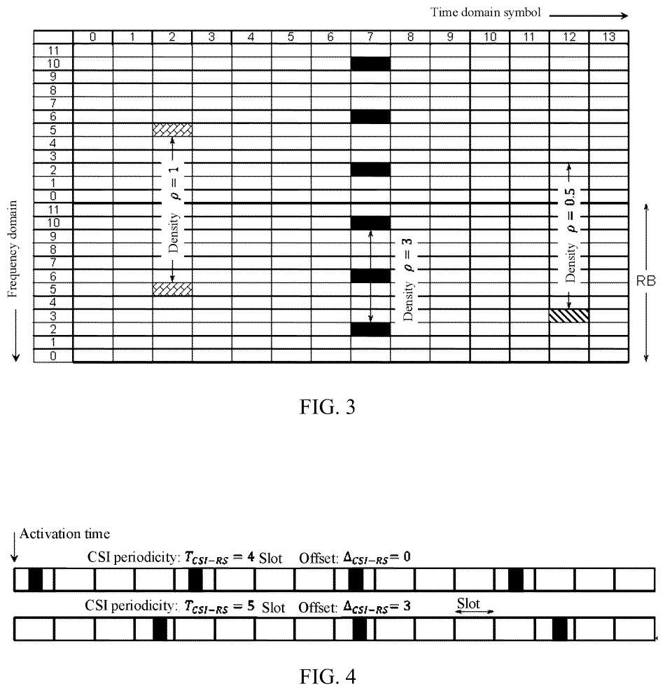

In an NR standard, the parameters k₀, I₀, ρ and cdm-Type are represented in Table 7.4.1.5.3-1 in the protocol TS 38.211. Configuration parameters illustrated on the left in FIG. 3 are as follows: A location of an OFDM frequency domain resource is 5, a time domain location of the first OFDM symbol is 2, a type of a physical resource is noCDM, and a density in each OFDM symbol is 1. Configuration parameters illustrated in the middle in FIG. 3 are as follows: A location of an OFDM frequency domain resource is 2, a time domain location of the first OFDM symbol is 7, a type of a physical resource is noCDM, and a density in each OFDM symbol is 3. Configuration parameters illustrated on the right in FIG. 3 are as follows: Alocation of an OFDM frequency domain resource is 3, a time domain location of the first OFDM symbol is 12, a type of a physical resource is noCDM, and a density in each OFDM symbol is 0.5.

A start location and the number of RBs of a CSI resource in frequency domain are respectively given by RRC parameters startingRB and nrofRBs in an information element CSI-FrequencyOccupation. Specifically, startingRB defines a start physical resource block (Physical Resource Block, PRB) of a CSI resource relative to a common resource block #0 (CRB #0), where a value is the number of PRB intervals from the CRB #0, and only a multiple of 4 is allowed. NrofRBs defines the number of PRBs spanned by a CSI resource, only a multiple of 4 is allowed, and a minimum configurable number is a minimum value between 24 and an associated bandwidth part (Bandwidth Part, BWP). If a configuration value is greater than a width of the associated BWP, UE should assume that an actual CSI-RS bandwidth is equal to the width of the associated BWP.

A sensing signal may be configured as a periodic sensing signal, or may be configured as an aperiodic sensing signal. When the sensing signal is configured as a periodic sensing signal, parameters T_{CSI-RS} and Δ_{CSI-RS} of the sensing signal may determine a periodic feature of the sensing signal.

More specifically, for a periodic CSI-RS, a CSI transmission sequence in a slot is implemented by a frame index and an RRC parameter CSI-ResourcePeriodicity AndOffset. It is assumed that configured CSI-RS transmission occurs in every T_{CSI-RS}^{th} slot, where T_{CSI-RS} is a resource periodicity with a range of T_{CSI-RS}=4, 5, 8, 10, 16, 20, . . . , 320, 640, and a CSI-RS location offset is represented by Δ_{CSI-RS}.

Two settings of CSI-RS resource periodicity 4 and 5 are shown in FIG. 4, where CSI-RS offsets are Δ_{CSI-RS}=0 and 3 respectively.

It is noted that a periodic CSI-RS offset is calculated based on an activation time (Activation Timing).

When a sensing signal is configured as an aperiodic sensing signal, corresponding downlink control information (Downlink Control Information, DCI) and an offset for CSI-RS sending are determined based on a parameter aperiodic triggering offset (aperiodicTriggeringOffset) in an information element NZP-CSI-RS-ResourceSet. That is, aperiodicTriggeringOffset is an offset between a slot that triggers DCI of an aperiodic CSI-RS resource set and a slot for sending a CSI-RS resource set.

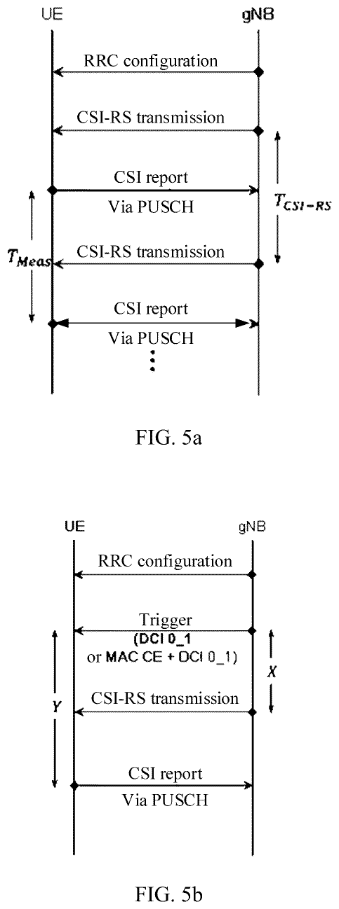

As shown in FIG. 5a, when a sensing signal is configured as a periodic sensing signal, a network side sends a CSI-RS based on a configured periodic slot. Similarly, UE side receives a CSI-RS based on a configured periodic slot, and calculates a required measurement number related to the CSI-RS. The UE side feeds back the measurement number related to the CSI-RS by using a configured physical uplink shared channel (Physical Uplink Sharing Channel, PUSCH). In an IE of CSI-MeasConfig, a CSI-RS periodicity T_{CSI-RS} is configured by using CSI-ResourcePeriodicityAndOffset, and a CSI measurement periodicity T_{Meas} is determined based on a resource periodicity configured by a PUSCH. Certainly, through RRC configuration, T_{CSI-RS}=T_{Meas}.

As shown in FIG. 5b, when a sensing signal is configured as an aperiodic sensing signal, a network side triggers CSI-RS sending and measurement by sending DCI 0_1 or MAC CE+DCI 0_1. The triggered CSI-RS is sent after the offset aperiodicTriggeringOffset starting from a slot of DCI. However, the triggered measurement is fed back after an offset CSI report slot offset list (CSIreportSlotOffsetList) starting from a slot of DCI. It should be noted that CSIreportSlotOffsetList and a PUSCH configuration offset are the same. In FIG. 5b, X represents aperiodicTriggeringOffset, and Y represents CSIreportSlotOffsetList, where CSIreportSlotOffsetList is equal to the PUSCH configuration offset.

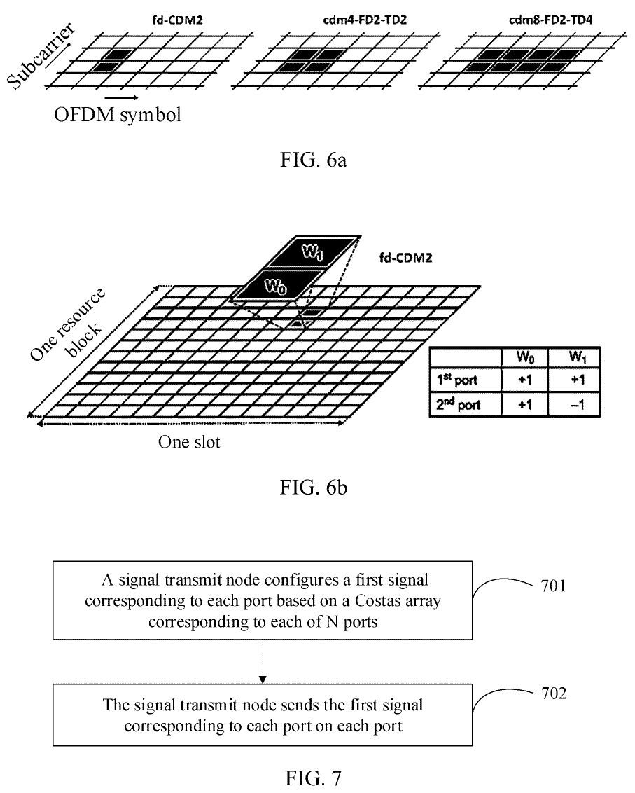

The number of ports (Port) of a CSI-RS resource may be a single port, or may be a plurality of ports (multi-port), and is up to 32 ports. CDM is used for multi-port mapping, that is, a plurality of CSI-RS ports may be distinguished and mapped on a same time-frequency resource in through CDM. Currently, there are four CDM types in NR, that is, noCDM, fd-CDM2, cdm4-FD2-TD2, and cdm8-FD2-TD4. FIG. 6a is a schematic diagram of several types of CDM. noCDM is the simplest, a CSI-RS is mapped to only one RE, and there is no code division. fd-CDM2 is to implement multiplexing of two ports on two subcarriers in frequency domain and two REs of one OFDM symbol in time domain. FIG. 6b is a schematic diagram of an orthogonal code of fd-CDM2. cdm4-FD2-TD2 is to implement multiplexing of four ports on two subcarriers in frequency domain and four REs of two OFDM symbols in time domain. cdm8-FD2-TD4 is to implement multiplexing of eight ports on two subcarriers in frequency domain and eight REs of four OFDM symbols in time domain.

A CDM type of a CSI-RS is configured by using an RRC parameter cdm-Type. An orthogonal code w_{f}(k′)·wₜ(l′) used by the CSI-RS may be obtained by querying Table 7.4.1.5.3-2 to Table 7.4.1.5.3-5 in the protocol TS 38.211. A value of an index k′ or l′ is 0 or 1, which affects a time-frequency location of a CSI-RS resource and controls a value of the orthogonal code.

In the information element CSI-RS-ResourceMapping, the number of CSI-RS ports is configured by using a parameter nrofPorts, and its value may be {p1, p2, p4, p8, p12, p16, p24, p32}, that is, corresponds to the number of ports of 1, 2, 4, 8, 12, 24, and 32 respectively. Table 7.4.1.5.3-1 in the protocol TS 38.211 specifies several combinations of the value of nrofPorts and cdm-Type, where a time-frequency resource location (k, l) of the CSI-RS is jointly affected by (k̅, l̅) and (k′, l′), and (k̅, l̅) is configured and calculated by using a bitmap (bitmap) of a resource parameter frequencyDomainAllocation in an information element CSI-RS-ResourceMapping or CSI-RS resource configuration mobility (CSI-RS-ResourceConfigMobility). A specific calculation method is as follows:
[b₃ . . . b₀], kᵢ₋₁=f(i) for a row 1 in Table 7.4.1.5.3-1;
[b₁₁ . . . b₀], kᵢ₋₁=f(i) for a row 2 in Table 7.4.1.5.3-1;
[b₂ . . . b₀], kᵢ₋₁=4f(i) for a row 4 in Table 7.4.1.5.3-1; and
[b₅ . . . b₀], kᵢ₋₁=2f(i) for other cases.
f(i) is a sequence number of a bitmap element 1 of a bitmap vector starting at 0 from right to left. The foregoing Table 7.4.1.5.3-1 is a table in the protocol TS 38.211.

A value of a group size (group size) of CDM is L∈{1,2,4,8}, which means that when the number of ports nrofPorts (assuming that a value is N) is greater than the group size of CDM, N/L CDM groups are required to implement multi-port resource mapping, and indexes of the CDM groups correspond to a column CDM group index j (CDM group index j) in Table 7.4.1.5.3-1 in the protocol TS 38.211. The indexes of the CDM groups are in ascending order first in frequency domain and then in descending order in time domain.

In each CDM group (Group), an index s is further used to identify orthogonal code division sequences of different ports, and s corresponds to a column index (index) in Table 7.4.1.5.3-2 to Table 7.4.1.5.3-5 in the protocol TS 38.211. A mapping relationship between port sequence numbers p specified by NR is p=3000+s+jL, j=0,1, . . . , N/L−1; s=0,1, . . . , L−1.

With reference to the accompanying drawings, the following describes in detail the signal transmission method provided in the embodiments of this application by using some embodiments and application scenarios thereof.

Referring to FIG. 7, FIG. 7 is a flowchart of a signal transmission method according to an embodiment of this application. The method may be executed by a signal transmit node, and the signal transmit node may be a terminal or a network side device. As shown in FIG. 7, the method includes the following steps.

Step 701: A signal transmit node configures a first signal corresponding to each port based on a Costas array corresponding to each of N ports, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service.

In this embodiment, each port may correspond to at least one Costas array or at least one Costas array set, and each Costas array set may include at least one Costas array. The foregoing Costas array may include at least one of a Welch-Costas array, a Golomb-Costas array, a Lempel-Costas array, and the like.

Costas arrays corresponding to all of the foregoing N ports may be the same, or Costas arrays corresponding to all of the foregoing N ports may be different, or in the foregoing N ports, some ports correspond to a same Costas array, and some ports correspond to different Costas arrays.

It should be noted that the configuring a first signal corresponding to each port based on a Costas array corresponding to each port may include configuring a time-frequency resource of the first signal corresponding to each port based on the Costas array corresponding to each port, so that each port can send the first signal corresponding to each port on the time-frequency resource of the first signal corresponding to each port.

Step 702: The signal transmit node sends the first signal corresponding to each port on each port.

For example, the signal transmit node includes a port A, a port B, and a port C. In this case, a first signal corresponding to the port A may be sent on the port A, a first signal corresponding to the port B is sent on the port B, and a first signal corresponding to the port C is sent on the port C.

According to the signal transmission method provided in this embodiment of this application, the signal transmit node configures the first signal corresponding to each port based on the Costas array corresponding to each of the N ports, and sends the first signal corresponding to each port on each port. Because the Costas array has a relatively ideal thumbtack ambiguity function, the first signal corresponding to each port is configured based on the Costas array corresponding to each port, so that anti-interference and resolution of the first signal corresponding to each port can be improved, thereby improving accuracy of multi-port sensing.

Optionally, Costas arrays corresponding to the N ports are different;
or

Costas arrays corresponding to M of the N ports are the same, where M is an integer greater than 1 and less than or equal to N.

In an implementation, the N ports may respectively correspond to different Costas arrays. In this way, a cross-correlation of first signals corresponding to different ports can be reduced, and a signal node can more accurately distinguish first signals of different ports, thereby improving accuracy of receiving a first signal.

In another implementation, Costas arrays corresponding to all of the foregoing N ports are the same, or Costas arrays corresponding to a part of the foregoing N ports are the same. Therefore, in a case that the number of available different Costas arrays is insufficient, first signals of a plurality of ports may still be configured based on Costas arrays.

Optionally, time-frequency resources of Costas arrays corresponding to at least two of the N ports are configured through at least one of time division multiplexing (Time-Division Multiplexing, TDM) and frequency division multiplexing (Frequency Division Multiplexing, FDM).

In this embodiment, time-frequency resources of Costas arrays corresponding to all of the foregoing N ports are configured through at least one of TDM and FDM, or time-frequency resources of Costas arrays corresponding to a part of the foregoing N ports are configured through at least one of TDM and FDM. In this way, the signal receive node can accurately distinguish first signals of different ports, thereby improving accuracy of receiving a first signal.

For example, it is assumed that Costas arrays corresponding to ports are shown in Table 4, and the arrays in Table 4 are obtained through search by using an optimization algorithm. A configured order of a Costas array is 5, and a mapping unit of the Costas array is two subcarriers in frequency domain and two REs of one OFDM symbol in time domain. A time interval between different mapping units of Costas arrays is two OFDM symbols.

It should be noted that the mapping unit in this embodiment of this application may be any combination of a bandwidth occupied by more than one consecutive subcarrier in frequency domain (for example, 2 to 11 consecutive subcarriers, or at least one consecutive RB or BWP) and a time length of more than one consecutive OFDM symbol in time domain (for example, 2 to 13 consecutive OFDM symbols, or at least one consecutive slot (Slot) or OFDM signal frame). In addition, 12 consecutive subcarriers in frequency domain and one slot in time domain are referred to as one RB, that is, 1 RB=12 subcarriers. Based on a bandwidth 15 kHz of one subcarrier, it can be learned that a bandwidth of one RB is 180 kHz. One subcarrier in frequency domain and one symbol (symbol) in time domain are referred to as one RE.

TABLE 4
Four 5-order Costas arrays with a low cross-correlation

| Index (Index) | Costas arrays of ports | | | | |
|---|---|---|---|---|---|
| 0 | 0 | 2 | 3 | 1 | 4 |
| 1 | 1 | 0 | 4 | 2 | 3 |
| 2 | 3 | 2 | 4 | 0 | 1 |
| 3 | 4 | 1 | 3 | 2 | 0 |

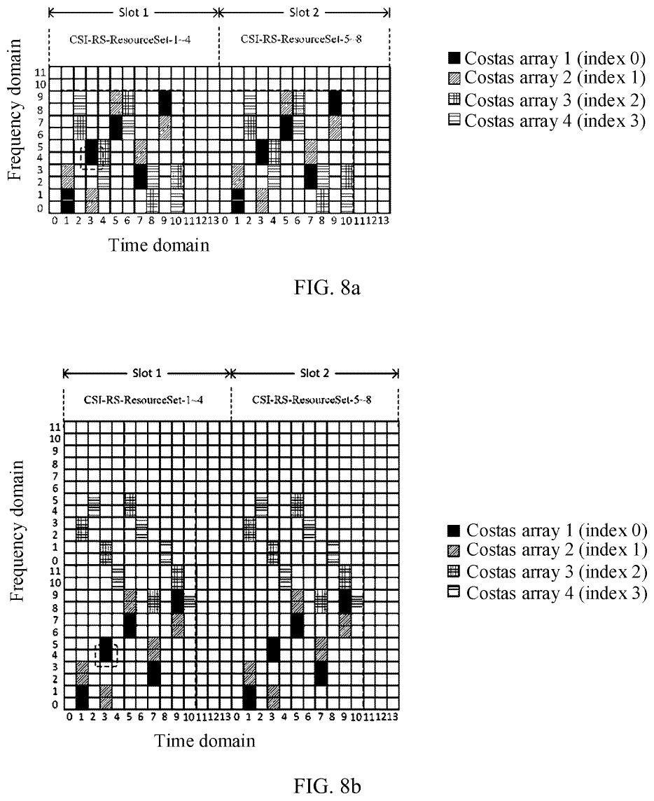

FIG. 8a and FIG. 8b show time-frequency resources of Costas arrays corresponding to four antenna ports, which are respectively represented by squares with different filling patterns. It can be learned from Table 4 that, in FIG. 8a, a Costas array 3 and a Costas array 4 are transmitted with a delay of one OFDM symbol relative to a Costas array 1 and a Costas array 2, that is, through TDM, it is ensured that the time-frequency resources of the Costas arrays corresponding to the four antenna ports do not overlap each other, thereby implementing relatively compact resource mapping. In FIG. 8b, a lowest frequency of a Costas array 3 is increased by eight subcarrier spacings relative to a Costas array 1 and a Costas array 2, and a lowest frequency of a Costas array 4 is increased by eight subcarrier spacings relative to the Costas array 1 and the Costas array 2 and the Costas array 4 is transmitted with a delay of one OFDM symbol, that is, through FDM and TDM, it is ensured that the time-frequency resources of the Costas arrays corresponding to the four antenna ports do not overlap each other.

Optionally, in a case that the Costas arrays corresponding to the M of the N ports are the same, time-frequency resources of the Costas arrays corresponding to the M ports are configured through at least one of TDM and FDM, where M is an integer greater than 1 and less than or equal to N.

In this embodiment, in a case that the Costas arrays corresponding to the M ports are the same (that is, the M ports share one Costas array), the time-frequency resources of the Costas arrays corresponding to the M ports may be configured through at least one of TDM and FDM, to ensure that the resources do not overlap each other, so that the signal receive node can accurately distinguish signals corresponding to different ports, thereby improving accuracy of receiving a signal.

For example, four Costas arrays are used to construct orthogonal signals of eight ports, where each two ports use one same Costas array, so that time-frequency resources of Costas arrays corresponding to the eight ports can be staggered pairwise through TDM and FDM.

Optionally, an overlapping part between time-frequency resources of Costas arrays corresponding to different ports is configured through CDM.

In this embodiment, in a case that there is an overlapping part between time-frequency resources of Costas arrays corresponding to different ports, the overlapping part between the time-frequency resources of the Costas arrays corresponding to the different ports may be configured through CDM, so that a cross-correlation between signals corresponding to different ports is further reduced.

Optionally, a correlation between a Costas array corresponding to a first port and a Costas array corresponding to a second port is less than a preset value, where the first port and the second port are two ports corresponding to different Costas arrays in the N ports.

For example, the N ports include a port A, a port B, and a port C, where the port A corresponds to a Costas array A, the port B corresponds to a Costas array B, and the port C corresponds to a Costas array A. A correlation between the Costas array A and the Costas array C is less than a preset value, where the preset value may be properly set based on an actual requirement.

In this embodiment, ports corresponding to different Costas arrays use Costas arrays with a relatively low cross-correlation. In this way, a cross-correlation between first signals corresponding to different ports can be reduced, so that the signal receive node can distinguish the first signals corresponding to the different ports.

Optionally, there is an overlapping part between a time-frequency resource of the Costas array corresponding to the first port and a time-frequency resource of the Costas array corresponding to the second port, and the overlapping part is not configured through CDM.

In this embodiment, in a case that there is an overlapping part between the time-frequency resource of the Costas array corresponding to the first port and the time-frequency resource of the Costas array corresponding to the second port, the overlapping part may not be configured through CDM. In this case, the signal receive node may separate signals of different ports through correlation de-hopping (correlation-based matching filtering) by using autocorrelation and cross-correlation features of Costas arrays.

Optionally, a time-frequency resource of a Costas array corresponding to a third port in the N ports and a time-frequency resource of a Costas array corresponding to a fourth port in the N ports are configured through TDM, and the Costas array corresponding to the third port and the Costas array corresponding to the fourth port are different;
and/or
a time-frequency resource of a Costas array corresponding to a fifth port in the N ports and a time-frequency resource of a Costas array corresponding to a sixth port in the N ports are configured through CDM, and the Costas array corresponding to the fifth port and the Costas array corresponding to the sixth port are the same.

In this embodiment, for a plurality of ports corresponding to different Costas arrays, time-frequency resources of the corresponding Costas arrays may be configured through TDM, to ensure that time-frequency resources of ports do not overlap; and for a plurality of ports corresponding to a same Costas array, a time-frequency resource of the corresponding Costas array may be configured through CDM, so that the signal receive node can distinguish signals corresponding to different ports.

Optionally, the method further includes:
sending, by the signal transmit node, at least one resource set identifier to a signal receive node, where a resource set indicated by each resource set identifier includes a time-frequency resource of a Costas array corresponding to at least one of the N ports;
or
sending, by the signal transmit node, a resource configuration identifier to a signal receive node, where the resource configuration identifier is used to indicate a first resource configuration, the first resource configuration includes at least one resource set, and each resource set includes a time-frequency resource of a Costas array corresponding to at least one of the N ports.

In an implementation, the signal transmit node may send the at least one resource set identifier to the signal receive node, to indicate a time-frequency resource of a Costas array to the signal receive node. In this way, flexibility of resource indication can be improved while overheads of resource indication are considered. Each resource set may include a time-frequency resource of a Costas array corresponding to one port, or each resource set may include time-frequency resources of Costas arrays corresponding to a plurality of ports. It may be understood that different resource sets separately include time-frequency resources of Costas arrays corresponding to different ports. In actual application, the signal transmit node may combine time-frequency resources of Costas arrays corresponding to the N ports into at least one resource set, and send a resource set identifier of each resource set to the signal receive node.

In another implementation, the signal transmit node may send the resource configuration identifier (ResourceConfigId) to the signal receive node, to indicate a time-frequency resource of a Costas array to the signal receive node. In this way, overheads of resource indication can be reduced compared with the indication manner of the resource set identifier. The first resource configuration (ResourceConfig) indicated by the resource configuration identifier includes at least one resource set. For the foregoing resource set, refer to the related descriptions of the foregoing implementation. Details are not described herein again.

It should be noted that in this embodiment of this application, the time-frequency resource of the first signal corresponding to each port may be determined based on a time-frequency resource of the Costas array corresponding to each port. For example, the time-frequency resource of the first signal corresponding to each port may be the time-frequency resource of the Costas array corresponding to each port. In this way, after the time-frequency resource of the Costas array corresponding to each port is configured, the first signal corresponding to each port may be sent on the time-frequency resource of the Costas array corresponding to each port.

Optionally, before the configuring, by a signal transmit node, a first signal corresponding to each port based on a Costas array corresponding to each of N ports, the method further includes:
sending, by the signal transmit node, first configuration information to the signal receive node, where the first configuration information is used to configure the first signal corresponding to each of the N ports;
and/or
receiving, by the signal transmit node, the first configuration information.

In this embodiment, the signal transmit node may receive the first configuration information from a first device, where the first device may include but is not limited to at least one of the following: a sensing function network element (Sensing Function, SF); an access and mobility management function (Access and Mobility Management Function, AMF) network element; and a sensing application server in a core network. Specifically, after receiving the first configuration information, the signal transmit node may configure the first signal corresponding to each of the N ports based on the first configuration information.

Optionally, the first configuration information includes at least one of the following:
a first configuration parameter, where the first configuration parameter is used to configure the Costas array corresponding to each of the N ports;
a second configuration parameter, where the second configuration parameter is used to configure a time-frequency location of the first signal corresponding to each of the N ports; and
a third configuration parameter, where the third configuration parameter is a port-related configuration parameter.

For example, in a case that the first configuration information includes the first configuration parameter, the Costas array corresponding to each of the N ports may be determined based on the first configuration parameter. In a case that the first configuration information includes the second configuration parameter, the time-frequency location of the Costas array corresponding to each of the N ports may be configured based on the second configuration parameter. In a case that the first configuration information includes the third configuration parameter, the port-related parameter may be determined based on the third configuration parameter, for example, the number of ports, the Costas array corresponding to each port, and the time-frequency location of the Costas array corresponding to each port.

Optionally, the first configuration parameter includes at least one of the following:
a Costas array type indication, where the Costas array type indication is used to indicate a type of the Costas array corresponding to each of the N ports;
a first prime number set, where the first prime number set includes a prime number used to generate the Costas array corresponding to each of the N ports;
a finite field primitive element set, where the finite field primitive element set includes a finite field primitive element used to generate the Costas array corresponding to each of the N ports; and
a finite field non-zero element set, where the finite field non-zero element set includes a finite field non-zero element used to generate the Costas array corresponding to each of the N ports.

In this embodiment, the type of the Costas array may include at least one of a Welch-Costas array, a Golomb-Costas array, and a Lempel-Costas array. For example, the Costas array type indication may include N type indications, that is, the N type indications respectively indicate types of the Costas arrays corresponding to the N ports, or the Costas array type indication may include one type indication, that is, one type indication indicates types of the Costas arrays corresponding to the N ports.

The first prime number set may include the prime number used to generate the Costas array corresponding to each port. For example, a prime number used to generate a Costas array corresponding to an m^{th} port in the first prime number set includes {l₁, l₂, . . . , lₙ}ₘ, where m=1,2, . . . , Mₚ, Mₚ (Mₚ≥2) represents a total number of configured ports, n(n≥2) represents a total number of Costas arrays configured for a single port, and l represents a prime number.

The finite field primitive element set may include the finite field primitive element used to generate the Costas array corresponding to each port. For example, a finite field primitive element used to generate a Costas array corresponding to an m^{th} port in the finite field primitive element set may include {α₁, α₂, . . . , αₙ}ₘ, or {α₁, α₂, . . . , αₙ}ₘ and {β₁, β₂, . . . , βₙ}ₘ, where m=1,2, . . . , Mₚ, Mₚ (Mₚ≥2) represents a total number of configured ports, n(n≥2) represents a total number of Costas arrays configured for a single port, and both α and β represent finite field primitive elements.

The finite field non-zero element set may include the finite field non-zero element used to generate the Costas array corresponding to each port. For example, a finite field non-zero element used to generate a Costas array corresponding to an m^{th} port in the finite field non-zero element set may include {η₁, η₂, . . . , ηₙ}ₘ, where Mₚ(Mₚ≥2) represents a total number of configured ports, n(n≥2) represents a total number of Costas arrays configured for a single port, and n represents a finite field non-zero element.

For example, a Costas array configuration parameter set used to generate different Costas arrays may be predefined. The Costas array configuration parameter set may include at least one of a finite field primitive element, a prime element, a finite field non-zero element, and the like used to generate different Costas arrays. In this way, the first prime number set, the finite field primitive element set, and the finite field non-zero element set may be obtained from the Costas array configuration parameter set.

In this embodiment, the Costas array corresponding to each port may be determined by using at least one of the Costas array type indication, the first prime number set, the finite field primitive element set, and the finite field non-zero element set through a formula method. For example, based on at least one of the Costas array type indication, the first prime number set, the finite field primitive element set, and the finite field non-zero element set, the Costas array corresponding to each port is determined by using at least one of the foregoing equation (1) to equation (4). In this way, flexibility of generating a Costas array can be improved.

Optionally, the first configuration parameter includes at least one of the following:
an order of the Costas array corresponding to each of the N ports;
an index of the Costas array corresponding to each of the N ports; and
an index of a Costas array set corresponding to each of the N ports.

For example, an order of a Costas array corresponding to an m^{th} port in the N ports may include {L₁, L₂, . . . , Lₙ}ₘ, where Mₚ(Mₚ≥2) represents a total number of configured ports, n(n≥2) represents a total number of Costas arrays configured for a single port, and L represents an order.

An index of a Costas array corresponding to an m^{th} port in the N ports may include {i₁, i₂, . . . , iₙ}ₘ, where Mₚ(Mₚ≥2) represents a total number of configured ports, n(n≥2) represents a total number of Costas arrays configured for a single port, and i represents an index of a Costas array.

An index of a Costas array set corresponding to an m^{th} port in the N ports may include {l₁, l₂, . . . , lₙ}ₘ, where Mₚ(Mₚ≥2) represents a total number of configured ports, n(n≥2) represents a total number of Costas arrays configured for a single port, and I represents an index of a Costas array set.

In this embodiment, the Costas array corresponding to each port may be determined by using at least one of the order of the Costas array corresponding to each port, the index of the Costas array corresponding to each port, and the index of the Costas array set corresponding to each port through a table look-up method. For example, a Costas array that matches an order of the foregoing Costas array is searched from a plurality of pre-constructed Costas arrays, or a Costas array that matches an index of the foregoing Costas array is searched from a plurality of pre-constructed Costas arrays. In this way, overheads of a parameter used to determine a Costas array can be reduced.

Optionally, the second configuration parameter includes at least one of the following:
a start frequency of the first signal corresponding to each of the N ports;
a start time of the first signal corresponding to each of the N ports;
a bandwidth of the first signal corresponding to each of the N ports;
duration of the first signal corresponding to each of the N ports;
a first frequency offset corresponding to each of the N ports, where the first frequency offset corresponding to each port is used to indicate an offset of a start frequency of the Costas array corresponding to each port relative to the start frequency of the first signal corresponding to each port;
a first time offset corresponding to each of the N ports, where the first time offset corresponding to each port is used to indicate an offset of a start time of the Costas array corresponding to each port relative to the start time of the first signal corresponding to each port;
a second frequency offset corresponding to each of the N ports, where the second frequency offset corresponding to each port is used to indicate an offset of a start frequency of the Costas array set corresponding to each port relative to the start frequency of the first signal corresponding to each port, and the Costas array set corresponding to each port includes at least one Costas array corresponding to each port;
a second time offset corresponding to each of the N ports, where the second time offset corresponding to each port is used to indicate an offset of a start time of the Costas array set corresponding to each port relative to the start time of the first signal corresponding to each port;
a third frequency offset corresponding to each of the N ports, where the third frequency offset corresponding to each port is used to indicate an offset of the start frequency of the Costas array corresponding to each port relative to a start frequency of a Costas array set to which the Costas array belongs;
a third time offset corresponding to each of the N ports, where the third time offset corresponding to each port is used to indicate an offset of the start time of the Costas array corresponding to each port relative to a start time of a Costas array set to which the Costas array belongs;
a first frequency domain periodicity corresponding to each of the N ports, where the first frequency domain periodicity corresponding to each port is used to indicate a frequency domain interval between Costas array sets corresponding to each port;
a first time domain periodicity corresponding to each of the N ports, where the first time domain periodicity corresponding to each port is used to indicate a time domain interval between Costas array sets corresponding to each port;
a second frequency domain periodicity corresponding to each of the N ports, where the second frequency domain periodicity corresponding to each port is used to indicate a frequency domain interval between Costas arrays in the Costas array set corresponding to each port;
a second time domain periodicity corresponding to each of the N ports, where the second time domain periodicity corresponding to each port is used to indicate a time domain interval between Costas arrays in the Costas array set corresponding to each port;
a first frequency domain repetition coefficient corresponding to each of the N ports, where the first frequency domain repetition coefficient corresponding to each port is used to indicate the number of Costas arrays included in the Costas array set corresponding to each port in frequency domain;
a first time domain repetition coefficient corresponding to each of the N ports, where the first time domain repetition coefficient corresponding to each port is used to indicate the number of Costas arrays included in the Costas array set corresponding to each port in time domain;
a second frequency domain repetition coefficient corresponding to each of the N ports, where the second frequency domain repetition coefficient corresponding to each port is used to indicate the number of Costas array sets corresponding to each port in frequency domain;
a second time domain repetition coefficient corresponding to each of the N ports, where the second time domain repetition coefficient corresponding to each port is used to indicate the number of Costas array sets corresponding to each port in time domain;
a Costas array modulation sequence parameter corresponding to each of the N ports;
a muting pattern (Muting Pattern) corresponding to each of the N ports; and
quasi co-location information of a time-frequency resource in which the Costas array corresponding to each of the N ports is located and another reference signal.

The start frequency of the first signal is used to indicate a lowest frequency location or a lowest carrier (Lowest Subcarrier) of the first signal, and may also be referred to as a frequency reference point. The start time of the first signal may represent a start time instant (Start Time Instant) of the first signal, and may be referred to as a time reference point.

The bandwidth of the first signal may represent a total frequency domain width occupied by the first signal. The duration of the first signal may represent a total time length occupied by the first signal.

The first frequency offset corresponding to each port is used to indicate the offset of the start frequency of the Costas array corresponding to each port relative to the start frequency of the first signal corresponding to each port. For example, a first frequency offset corresponding to a port A is used to indicate an offset of a start frequency of a Costas array corresponding to the port A relative to a start frequency of a first signal corresponding to the port A. Optionally, the first frequency offset may be represented by the number of REs, the number of RBs, or the like. It should be noted that the first frequency offset is applied to a Costas array.

The first time offset corresponding to each port is used to indicate the offset of the start time of the Costas array corresponding to each port relative to the start time of the first signal corresponding to each port. For example, a first time offset corresponding to a port A is used to indicate an offset of a start time of a Costas array corresponding to the port A relative to a start time of a first signal corresponding to the port A. Optionally, the first time offset may be represented by the number of OFDM symbols, the number of slots (Slot), or the like. It should be noted that the first time offset is applied to a Costas array.

The second frequency offset corresponding to each port is used to indicate the offset of the start frequency of the Costas array set corresponding to each port relative to the start frequency of the first signal corresponding to each port. For example, a second frequency offset corresponding to a port A is used to indicate an offset of a start frequency of a Costas array set corresponding to the port A relative to a start frequency of a first signal corresponding to the port A. Optionally, the second frequency offset may be represented by the number of REs, the number of RBs, or the like. It should be noted that the second frequency offset is applied to a Costas array set.

The second time offset corresponding to each port is used to indicate the offset of the start time of the Costas array set corresponding to each port relative to the start time of the first signal corresponding to each port. For example, a second time offset corresponding to a port A is used to indicate an offset of a start time of a Costas array set corresponding to the port A relative to a start time of a first signal corresponding to the port A. Optionally, the second time offset may be represented by the number of OFDM symbols, the number of slots (Slot), or the like. It should be noted that the second time offset is applied to a Costas array set.

The third frequency offset corresponding to each port is used to indicate the offset of the start frequency of the Costas array corresponding to each port relative to the start frequency of the Costas array set to which the Costas array belongs. For example, if a Costas array corresponding to a port A belongs to a Costas array set A, a third frequency offset corresponding to the port A is used to indicate an offset of a start frequency of the Costas array corresponding to the port A relative to a start frequency of the Costas array set A. Optionally, the third frequency offset may be represented by the number of REs, the number of RBs, or the like.

The third time offset corresponding to each port is used to indicate the offset of the start time of the Costas array corresponding to each port relative to the start time of the Costas array set to which the Costas array belongs. For example, if a Costas array corresponding to a port A belongs to a Costas array set A, a third time offset corresponding to the port A is used to indicate an offset of a start time of the Costas array corresponding to the port A relative to a start time of the Costas array set A. Optionally, the third time offset may be represented by using the number of REs, the number of RBs, or the like.

The first frequency domain periodicity corresponding to each port is used to indicate the frequency domain interval between the Costas array sets corresponding to each port. For example, a first frequency domain periodicity corresponding to a port A is used to indicate a frequency domain interval between Costas array sets corresponding to the port A. In other words, for a plurality of Costas array sets corresponding to each port, the plurality of Costas array sets may be evenly and equally distributed in frequency domain, and an interval between the plurality of Costas array sets is the first frequency domain periodicity. It should be noted that the first frequency domain periodicity is applied to a Costas array set.

The first time domain periodicity corresponding to each port is used to indicate the time domain interval between the Costas array sets corresponding to each port. For example, a first time domain periodicity corresponding to a port A is used to indicate a time domain interval between Costas array sets corresponding to the port A. In other words, for a plurality of Costas array sets corresponding to each port, the plurality of Costas array sets may be evenly and equally distributed in time domain, and an interval between the plurality of Costas array sets is the first time domain periodicity. It should be noted that the first time domain periodicity is applied to a Costas array set.

The second frequency domain periodicity corresponding to each port is used to indicate the frequency domain interval between the Costas arrays in the Costas array set corresponding to each port. For example, a second frequency domain periodicity corresponding to a port A is used to indicate a frequency domain interval between Costas arrays in a Costas array set corresponding to the port A. In other words, for the Costas array set corresponding to each port, a plurality of Costas arrays in the Costas array set may be evenly and equally distributed in frequency domain, and a frequency domain interval between the plurality of Costas arrays is the second frequency domain periodicity.

The second time domain periodicity corresponding to each port is used to indicate the time domain interval between the Costas arrays in the Costas array set corresponding to each port. For example, a second time domain periodicity corresponding to a port A is used to indicate a time domain interval between Costas arrays in a Costas array set corresponding to the port A. In other words, for the Costas array set corresponding to each port, a plurality of Costas arrays in the Costas array set may be evenly and equally distributed in time domain, and a time domain interval between the plurality of Costas arrays is the second time domain periodicity.

The first frequency domain repetition coefficient corresponding to each port is used to indicate the number of Costas arrays included in the Costas array set corresponding to each port in frequency domain. For example, a first frequency domain repetition coefficient corresponding to a port A is used to indicate the number of Costas arrays included in a Costas array set corresponding to the port A. In other words, for the Costas array set corresponding to each port, the number of Costas arrays included in the Costas array set in frequency domain is the first frequency domain repetition coefficient.

The first time domain repetition coefficient corresponding to each port is used to indicate the number of Costas arrays included in the Costas array set corresponding to each port in time domain. For example, a first time domain repetition coefficient corresponding to a port A is used to indicate the number of Costas arrays included in a Costas array set corresponding to the port A. In other words, for the Costas array set corresponding to each port, the number of Costas arrays included in the Costas array set in time domain is the first time domain repetition coefficient.

The second frequency domain repetition coefficient corresponding to each port is used to indicate the number of Costas array sets corresponding to each port in frequency domain. For example, a second frequency domain repetition coefficient corresponding to a port A is used to indicate the number of Costas array sets corresponding to the port A in frequency domain.

The second time domain repetition coefficient corresponding to each port is used to indicate the number of Costas array sets corresponding to each port in time domain. For example, a second time domain repetition coefficient corresponding to a port A is used to indicate the number of Costas array sets corresponding to the port A in time domain.

The Costas array modulation sequence parameter may include at least one of the following: an initialization seed, that is, an input parameter of a pseudo random sequence generator, used to generate a pseudo random sequence of a first signal; and a sequence index. It should be noted that the Costas array or the Costas array set corresponding to each port indicates only a time-frequency location of the first signal, and the time-frequency location may further carry a predetermined symbol sequence (that is, a symbol sequence of the first signal). Specifically, the symbol sequence of the first signal may be modulated at the time-frequency location based on the Costas array modulation sequence parameter.

The muting pattern may be a defined bitmap (bitmap), and is used to indicate a time (symbol/slot) location in a resource of a first signal at which the first signal is muted, that is, the first signal is not transmitted at the time location.

Optionally, the third configuration parameter includes at least one of the following:
a first index, where the first index is used to indicate first information, and the first information includes at least one of the following: a port, a CDM group or a port group, a Costas array or a Costas array set, a multiplexing manner, and a time-frequency location of a Costas array;
information about a CDM group or a port group, where the CDM group or the port group includes at least one port;
a port index allocated to the signal receive node in a CDM group or a port group;
the number of CDM groups or port groups;
the number of ports in a CDM group or a port group;
the number of ports used for transmitting the first signal or the number of ports
allocated for sensing measurement;
a minimum port number; and
a maximum port number.

It should be noted that a port in this embodiment is a port used for transmitting the first signal in the signal transmit node.

For example, a mapping relationship between at least two of the following parameters may be established: a port, a CDM group or a port group, a Costas array or a Costas array set, a multiplexing manner, a time-frequency location or a time-frequency pattern (pattern) of a Costas array or a Costas array set. In this way, one of the parameters may be used to learn at least one parameter corresponding to the parameter. For example, at least one of a Costas array or a Costas array set, a multiplexing manner, a time-frequency domain location or a time-frequency pattern of a Costas array or a Costas array set is mapped to a port. In this way, an index of the port may indicate the port and at least one of the Costas array or the Costas array set, the multiplexing manner, and the time-frequency domain location or the time-frequency pattern of the Costas array or the Costas array set. In this way, overheads of parameter indication can be saved.

Optionally, the multiplexing manner includes at least one of FDM, TDM, and CDM.

Optionally, the first index includes at least one of the following:
a port index (Port Index);
a CDM group index or a port group index; and
an index of a Costas array or an index of a Costas array set.

For example, the port index (Port Index) may be used to indicate a mapping relationship between different ports and at least one of a specific time-frequency domain pattern (pattern), a CDM manner (cdm-Type), another scrambling manner, and the like.

The CDM group or the port group may include at least one port, that is, the CDM group or the port group may correspond to at least one port index. It should be noted that Costas signals (that is, first signals configured based on Costas arrays) corresponding to different CDM groups have a same time-frequency domain pattern.

The port group may be understood as a port group obtained by performing port grouping according to a rule different from a CDM grouping-based rule. Specifically, different from a DMRS or a CSI-RS, Costas configuration is more flexible, and more ports may be mapped based on different patterns or CDM manners or scrambling manners. Therefore, it is considered to perform port grouping and related indication according to another rule (that is, different from the CDM grouping-based rule).

It should be noted that, in this embodiment, a time-frequency domain configuration parameter may be determined based on the port index, the CDM group index, or the port group index.

It should be noted that, in a case that ports are allocated in ascending order or descending order, notifying the minimum port number and/or the maximum port number is equivalent to notifying all port numbers.

Optionally, before the configuring, by a signal transmit node, a first signal corresponding to each port based on a Costas array corresponding to each of N ports, the method includes:
determining, by the signal transmit node, the Costas array corresponding to each of the N ports.

In this embodiment, the signal transmit node determines the Costas array corresponding to each of the N ports. For example, the signal transmit node may determine the first configuration information, and determine the Costas array corresponding to each of the N ports based on the first configuration information; or the signal transmit node may determine the Costas array corresponding to each of the N ports based on the Costas array corresponding to each of the N ports preconfigured by the first device.

Optionally, the determining, by the signal transmit node, the Costas array corresponding to each of the N ports includes:
determining, by the signal transmit node, the Costas array corresponding to each of the N ports based on a first configuration parameter, where the first configuration parameter includes at least one of the following:
a Costas array type indication, where the Costas array type indication is used to indicate a type of the Costas array corresponding to each of the N ports;
a first prime number set, where the first prime number set includes a prime number used to generate the Costas array corresponding to each of the N ports;
a finite field primitive element set, where the finite field primitive element set includes a finite field primitive element used to generate the Costas array corresponding to each of the N ports; and
a finite field non-zero element set, where the finite field non-zero element set includes a finite field non-zero element used to generate the Costas array corresponding to each of the N ports; or
the first configuration parameter includes at least one of the following:
an order of the Costas array corresponding to each of the N ports;
an index of the Costas array corresponding to each of the N ports; and
an index of a Costas array set corresponding to each of the N ports.

For the first configuration parameter in this embodiment, refer to the related descriptions of the foregoing embodiment. Details are not described herein again.

For example, in a case that the first configuration information includes at least one of the Costas array type indication, the first prime number set, the finite field primitive element set, and the finite field non-zero element set, the signal transmit node may determine the Costas array corresponding to each port based on at least one of the Costas array type indication, the first prime number set, the finite field primitive element set, and the finite field non-zero element set by using a formula method, for example, determine the Costas array corresponding to each port based on at least one of the Costas array type indication, the first prime number set, the finite field primitive element set, and the finite field non-zero element set by using at least one of the foregoing equation (1) to equation (4); or in a case that the first configuration information includes at least one of the order of the Costas array corresponding to each port, the index of the Costas array corresponding to each port, and the index of the Costas array set corresponding to each port, the signal transmit node may determine the Costas array corresponding to each port based on at least one of the order of the Costas array corresponding to each port, the index of the Costas array corresponding to each port, and the index of the Costas array set corresponding to each port by using a table lookup method, for example, search the Costas array that matches the order of the Costas array from a plurality of pre-constructed Costas arrays, or search the Costas array that matches the index of the Costas array from a plurality of pre-constructed Costas arrays.

Optionally, the configuring, by a signal transmit node, a first signal corresponding to each port based on a Costas array corresponding to each of N ports includes:
configuring, by the signal transmit node, the first signal corresponding to each port based on the Costas array corresponding to each of the N ports and a configuration parameter of a CSI-RS.

The configuration parameter of the CSI-RS may include at least one of parameters CSI-RS-ResourceMapping, CSI-ResourcePeriodicityAndOffset, and the like in an information element NZP-CSI-RS-Resource. For the foregoing parameters CSI-RS-ResourceMapping and CSI-ResourcePeriodicity AndOffset, refer to the foregoing descriptions. Details are not described herein again.

The following describes this embodiment with reference to an example. The Costas signal may be understood as a first signal configured based on the Costas array.

### Example 1: Multi-Port Costas Signal Method Configured Based on a Non-CDM (No CDM) CSI-RS

For example, it is assumed that Costas arrays corresponding to ports are shown in Table 4, and the arrays in Table 4 are obtained through search by using an optimization algorithm. A configured order of a Costas array is 5, and a mapping unit of the Costas array is two subcarriers in frequency domain and two REs of one OFDM symbol in time domain. A time interval between different mapping units of Costas arrays is two OFDM symbols.

In this embodiment, a CDM configuration manner in a CSI-RS is not used. Theoretically, even if a plurality of antenna ports map some time-frequency resources at the same time, because of a frequency hopping property of a Costas array, based on autocorrelation and cross-correlation features of a complete frequency hopping sequence, a signal receive node can separate signals of different transmit antenna ports. However, in a case that time-frequency resources are sufficient for sensing/integrated sensing and communication, or available resources of a Costas array set are limited, orthogonality of an OFDM subcarrier may be used to implement orthogonality between Costas array signals of different ports in any one of TDM, FDM, and CDM. This embodiment describes a signal configuration method based on TDM and/or FDM.

FIG. 8a and FIG. 8b show time-frequency resources of Costas arrays corresponding to four antenna ports, which are respectively represented by squares with different filling patterns. It can be learned from Table 4 that, in FIG. 8a, a Costas array 3 and a Costas array 4 are transmitted with a delay of one OFDM symbol relative to a Costas array 1 and a Costas array 2, that is, through TDM, it is ensured that the time-frequency resources of the Costas arrays corresponding to the four antenna ports do not overlap each other, thereby implementing relatively compact resource mapping. In FIG. 8b, a lowest frequency of a Costas array 3 is increased by eight subcarrier spacings relative to a Costas array 1 and a Costas array 2, and a lowest frequency of a Costas array 4 is increased by eight subcarrier spacings relative to the Costas array 1 and the Costas array 2 and the Costas array 4 is transmitted with a delay of one OFDM symbol, that is, through FDM and TDM, it is ensured that the time-frequency resources of the Costas arrays corresponding to the four antenna ports do not overlap each other.

The signal configuration method provided in this embodiment may be specifically as follows:

Step a1: Determine, based on a requirement of a sensing service or an integrated sensing and communication service, a Costas array that is used to construct a signal (that is, a first signal) related to the sensing service or related to the integrated sensing and communication service, that is, determine a time-frequency resource location of at least one Costas array on each port (the number of ports≥2).

Step a2: Configure a time-frequency domain resource in each slot (Slot) by using RRC parameters CSI-RS-ResourceMapping and CSI-ResourcePeriodicityAndOffset in an information element NZP-CSI-RS-Resource. Specifically, taking an RE circled by a dotted-line corner box in FIG. 8a as an example, a parameter frequencyDomainAllocation corresponding to an information element CSI-RS-ResourceMapping is set to row 2, a corresponding bitmap is ‘000000010000’ (that is, k₀ in Table 7.4.1.5.3-1 in the 3GPP protocol TS 38.211 is 4), and a parameter firstOFDMSymbolInTimeDomain (that is, l₀ in Table 7.4.1.5.3-1 in the 3GPP protocol TS 38.211) is configured as 3. cdm-Type is non-CDM (noCDM).

For FIG. 8a, a frequency domain density parameter ρ in Table 7.4.1.5.3-1 in the 3GPP protocol TS 38.211 may be configured as 1, that is, a sensing signal on the RE is repeated in each RB. For FIG. 8b, a frequency domain density parameter ρ is configured as 0.5, that is, a sensing signal on the RE is repeated for every two adjacent RBs.

Step a3: Repeat the operation in step a2 to configure all time-frequency locations in a Costas array 1 in the slot on the RB. Each configured Costas array resource grid is one NZP-CSI-RS-Resource. For example, the RE circled by the dotted-line corner box in the figure may be numbered as CSI-RS-Resource3. One Costas array in FIG. 8a may form one NZP-CSI-RS-ResourceSet including a total of 10 NZP-CSI-RS-Resource, which corresponds to one antenna port. A slot 1 (Slot 1) includes four NZP-CSI-RS-ResourceSet.

Further, a start location in frequency domain and the number of RBs occupied by the CSI resource configured in step a2 and step a3 are configured by using RRC parameters startingRB and nrofRBs in an information element CSI-FrequencyOccupation. For example, in FIG. 8a, startingRB=24 and nrofRBs=24 are configured.

Step a4: Implement a periodicity and a related resource offset of a Costas array by configuring a parameter CSI-ResourcePeriodicityAndOffset.

Specifically, as shown in FIG. 8a, for NZP-CSI-RS-Resource in NZP-CSI-RS-ResourceSet (CSI-RS-ResourceSet 1 to 4 in the figure) in a slot 1 (Slot 1), a parameter CSI-ResourcePeriodicityAndOffset (Δ_{CSI-RS}) may be configured as 0; for NZP-CSI-RS-Resource in NZP-CSI-RS-ResourceSet (CSI-RS-ResourceSet 5 to 8 in the figure) in a slot 2 (Slot 2), a parameter CSI-ResourcePeriodicityAndOffset (Δ_{CSI-RS}) may be configured as 1. In addition, four NZP-CSI-RS-ResourceSet may be configured for each port, and a periodicity T_{CSI-RS} of each NZP-CSI-RS-ResourceSet is set to 4, but values of Δ_{CSI-RS} are 0, 1, 2, and 3 respectively, to implement dense and periodical signals shown in FIG. 8a. The same is true for FIG. 8b.

Step a5: Map a sensing resource to an antenna port.

In this embodiment, antenna ports are in a one-to-one correspondence with mapping resources of different Costas arrays. For example, assuming that antenna port numbers are 3000 to 3004, a mapping relationship may be that resources (CSI-RS-ResourceSet-1 and CSI-RS-ResourceSet-5 in FIG. 8) of a Costas array 1 are mapped to the port 3000; resources (CSI-RS-ResourceSet-2 and CSI-RS-ResourceSet-6 in FIG. 8) of a Costas array 2 are mapped to the port 3001; resources (CSI-RS-ResourceSet-3 and CSI-RS-ResourceSet-7 in FIG. 8) of a Costas array 3 are mapped to the port 3002; and resources (CSI-RS-ResourceSet-4 and CSI-RS-ResourceSet-8 in FIG. 8) of a Costas array 4 are mapped to the port 3004. It may be understood that the foregoing port numbers 3000 to 3004 are only used as an example, and may be actually any predetermined port number.

The CSI-RS-ResourceSet-1 to the CSI-RS-ResourceSet-8 may form CSI-ResourceConfig, and CSI-ResourceConfigId may represent an ID of a Costas array set. When a base station sends a sensing/integrated sensing and communication signal and UE receives the signal, the CSI-ResourceConfigId notifies the sensing UE by using a bit field (Bit Field) in DCI or MAC-CE signaling.

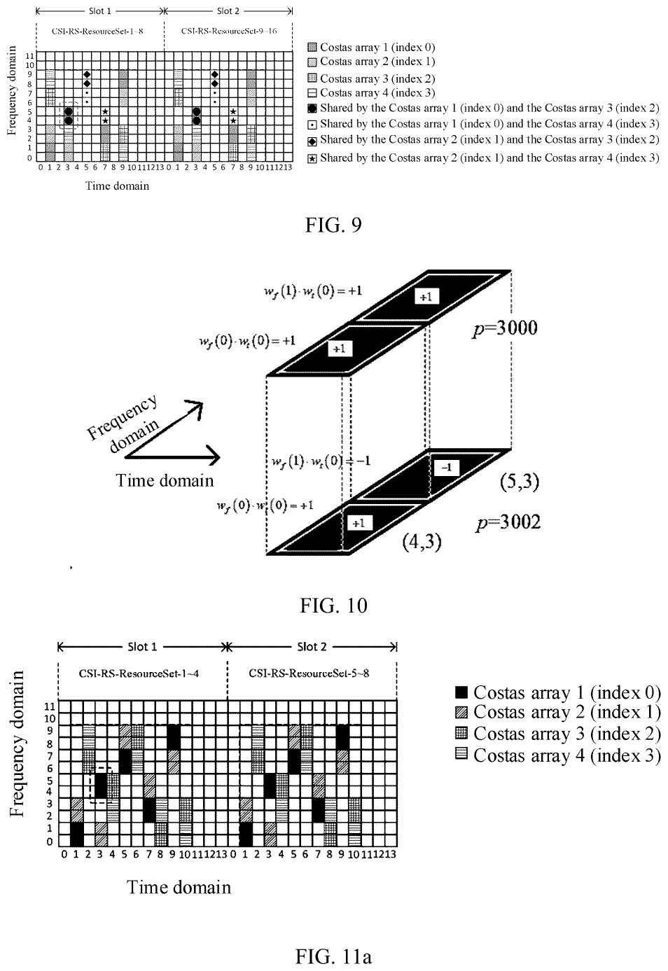

It should be noted that when K(K≥2) Costas arrays with a low pairwise cross-correlation are used, some mapping units of different Costas arrays may be overlapping sensing resources, and CDM multiplexing is not required. As shown in FIG. 9, Costas arrays listed in Table 4 are still used as an example. In this case, a signal receive node needs to separate signals of different ports through correlation de-hopping (correlation-based matching filtering) by using autocorrelation and cross-correlation features of Costas arrays.

For the example shown in FIG. 9, a signal configuration method is the same as the foregoing steps a1 to a4. For overlapping resources in each slot, one NZP-CSI-RS-ResourceSet may be configured separately. In step a5, a mapping relationship may be that resources (CSI-RS-ResourceSet 1, 5, 6, 9, 13, and 14 in FIG. 9) of a Costas array 1 are mapped to the port 3000; resources (CSI-RS-ResourceSet 2, 7, 8, 10, 15, and 16 in FIG. 9) of a Costas array 2 are mapped to the port 3001; resources (CSI-RS-ResourceSet 3, 6, 8, 11, 14, and 16 in FIG. 9) of a Costas array 3 are mapped to the port 3002; and resources (CSI-RS-ResourceSet 4, 6, 8, 12, 14, and 16 in FIG. 9) of a Costas array 4 are mapped to the port 3004.

It should be noted that, when the number of ports N>K, at least two different ports may use one same Costas array, and a mapping manner of Costas array time-frequency resources corresponding to the at least two different ports may be TDM and/or FDM, to ensure that the resources does not overlap each other. For example, four Costas arrays are used to construct orthogonal signals of eight ports, where each two ports use one same Costas array, so that time-frequency resources of Costas arrays corresponding to the eight ports can be staggered pairwise through TDM and FDM. A specific signal configuration method is the same as the foregoing step a1 to step a4, and details are not described herein again.

It should be noted that the first signal configured based on the Costas array in this embodiment of this application may be used for f communication synchronization and channel estimation in addition to parameter estimation for a sensing target/sensing area.

### Example 2: First Multi-Port Costas Signal Method Configured Based on a CDM CSI-RS

The specific multi-port Costas signal configuration method in this embodiment is still described by using FIG. 9. It is assumed that the number of CSI-RS antenna ports that need to be configured is 4, and each mapping unit of a Costas array occupies two subcarriers in frequency domain and one symbol in time domain. It can be learned that two ports have overlapping time-frequency resources. Therefore, port multiplexing may be performed through fd-CDM2. In actual configuration, this part of time-frequency resource is one CSI-RS-Resource. As shown in FIG. 9, two REs are circled by a dotted-line corner box, and the CSI-RS-Resource belongs to a CSI-RS-ResourceSet-5. When there is a plurality of groups of overlapping time-frequency resources, one or more NZP-CSI-RS-ResourceSet may be configured.

The signal configuration method provided in this embodiment is specifically as follows:

Step b1: Determine, based on a requirement of a sensing service or an integrated sensing and communication service, a Costas array that is used to construct a signal related to the sensing service or related to the integrated sensing and communication service, that is, determine a time-frequency resource location of at least one Costas array on each port (the number of ports≥2).

Step b2: Configure a time-frequency domain resource in each slot (Slot) by using RRC parameters CSI-RS-ResourceMapping and CSI-ResourcePeriodicityAndOffset in an information element NZP-CSI-RS-Resource. For a dedicated resource of a single Costas array, a configuration method is the same as that in Example 1. For overlapping time-frequency resources of Costas arrays of ports, the CSI-RS CDM configuration method is used. Taking a basic mapping unit circled by the dotted-line corner box in FIG. 9 as an example, configuration parameters in an information element CSI-RS-ResourceMapping may be:

$$\begin{matrix}density = 1 ; \\ nrofPorts = p 2 ; \\ cdm - Type = FD - CDM 2 ;\end{matrix}$$

frequencyDomainAllocation=other and bitmap is 000100; and
firstOFDMSymbolinTimeDomain=3.

The foregoing parameters may correspond to Row 3 in Table 7.4.1.5.3-1 in the protocol TS 38.211. In this case, k′[0]=0, k′[1]=1, and l′[0]=0. Based on the calculation method of the foregoing (k̅,l̅), k₀=2f(1)=2·2=4; and l₀=3. Therefore, time-frequency resource locations of two ports are:

$$\begin{matrix}( k , l ) = ( {k}_{0} + {k}^{′} [ 0 ] , {l}_{0} + {l}^{′} [ 0 ] ) , ( {k}_{0} + {k}^{′} [ 1 ] , {l}_{0} + {l}^{′} [ 0 ] ) , \\ = ( 4 + 0 , 3 + 0 ) , ( 4 + 1 , 3 + 0 ) , \\ = ( 4 , 3 ) , ( 5 , 3 )\end{matrix}$$

Based on the foregoing calculation result, a time-frequency resource location shared by one mapping unit of the Costas array 1 and the Costas array 3 marked in FIG. 9 may be determined.

With reference to Table 7.4.1.5.3-3 in the protocol TS 38.211, it can be learned that a CDM orthogonal code corresponding to the foregoing resource is shown in FIG. 10.

Step b3: Repeat the operation in step b2 to configure all time-frequency locations in a Costas array 1 in the slot on the RB. It should be noted that for other overlapping mapping units (CSI-RS-ResourceSet 6, 7, and 8 in the figure) in the slot 1 in FIG. 9, a configuration method is the same as that described in step b2.

Step b4: Implement a periodicity and a related resource offset of a Costas array by configuring a parameter CSI-ResourcePeriodicityAndOffset. This step is the same as that in Example 1, and details are not described herein.

Step b5: Map a sensing resource to an antenna port. It should be noted that, CSI-RS-ResourceSet 5, 6, 7, and 8 in FIG. 9 are configured based on a port number of 2. However, when these resources are being configured, the port number allocation method specified in TS 38.211 cannot be used, but a port number should be allocated based on a predetermined mapping relationship between a Costas array and a port. A mapping relationship may be the CSI-RS-ResourceSet-5 (that is, (k, l)=(4,3), (5,3)) corresponds to ports 3000 and 3002; the CSI-RS-ResourceSet-6 (that is, (k, l)=(6,5), (7,5)) corresponds to port 3000 and 3003; the CSI-RS-ResourceSet-7 (that is, (k, l)=(8,5), (9,5)) corresponds to ports 3002 and 3001; and the CSI-RS-ResourceSet-8 (that is, (k, l)=(4,7), (5,7)) corresponds to ports 3003 and 3001.

### Example 3: Second Multi-Port Costas Signal Method Configured Based on a CDM CSI-RS

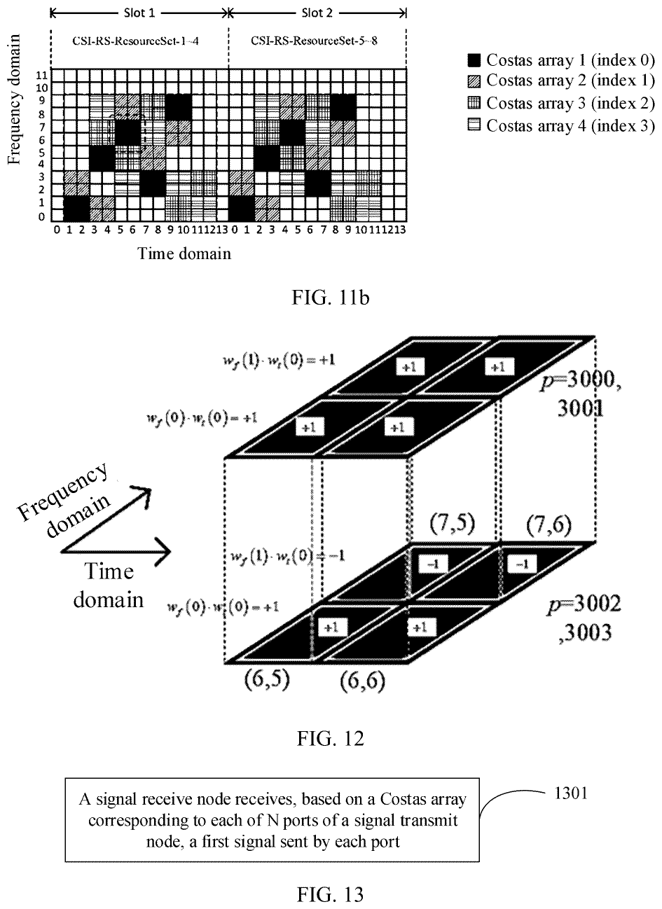

This embodiment is mainly used to describe a configuration method in which at least two ports multiplex one same Costas array when the number of available different Costas arrays is less than the number of ports. Still taking the four Costas arrays listed in Table 4 as an example, FIG. 1la is an example of a Costas signal pattern with a port number of 8, and FIG. 11b is an example of a Costas signal pattern with a port number of 16. In this embodiment, it is ensured that time-frequency resources do not overlap each other for the four Costas arrays through TDM. However, each Costas array is multiplexed by two (FIG. 11a) or four (FIG. 11b) antenna ports through CDM.

The signal configuration method provided in this embodiment is specifically as follows:

Step c1: Determine, based on a requirement of a sensing service or an integrated sensing and communication service, a Costas array set used to construct a sensing/integrated sensing and communication signal, that is, determine a time-frequency resource location of at least one Costas array on each port (the number of ports≥2).

Step c2: Configure a time-frequency domain resource in each slot (Slot) by using RRC parameters CSI-RS-ResourceMapping and CSI-ResourcePeriodicityAndOffset in an information element NZP-CSI-RS-Resource.

For each mapping unit of each Costas array, the CSI-RS CDM configuration method is used. Taking a mapping unit circled by a dotted circle corner box in FIG. 11a, configuration parameters in an information element CSI-RS-ResourceMapping may be:

$$\begin{matrix}density = 1 ; \\ nrofPorts = p 2 ; \\ cdm - Type = FD - CDM 2 ;\end{matrix}$$

frequencyDomainAllocation=other and bitmap is 000100; and
firstOFDMSymbolinTimeDomain=3.

The foregoing parameters may correspond to Row 3 in Table 7.4.1.5.3-1 in the protocol TS 38.211. In this case, k′[0]=0, k′[1]=1, and l′[0]=0. Based on the calculation method of the foregoing (k̅,l̅), k₀=2f(1)=2·2=4; and l₀=3. Therefore, time-frequency resource locations of two ports are:

$$\begin{matrix}( k , l ) = ( {k}_{0} + {k}^{′} [ 0 ] , {l}_{0} + {l}^{′} [ 0 ] ) , ( {k}_{0} + {k}^{′} [ 1 ] , {l}_{0} + {l}^{′} [ 0 ] ) , \\ = ( 4 + 0 , 3 + 0 ) , ( 4 + 1 , 3 + 0 ) , \\ = ( 4 , 3 ) , ( 5 , 3 )\end{matrix}$$

Based on the foregoing calculation result, a time-frequency resource location shared by one mapping unit of the Costas array 1 marked in FIG. 11a may be determined. It should be noted that the time-frequency resource is multiplexed by two antenna ports.

With reference to Table 7.4.1.5.3-3 in the protocol TS 38.211, it can be learned that a CDM orthogonal code corresponding to the foregoing resource is shown in FIG. 10.

Then, taking a mapping unit circled by a dotted circle corner box in FIG. 11b, configuration parameters in an information element CSI-RS-ResourceMapping may be:

$$\begin{matrix}density = 1 ; \\ nrofPorts = p 4 ; \\ cdm - Type = FD - CDM 2 ;\end{matrix}$$

frequencyDomainAllocation=other and bitmap is 001000; and
firstOFDMSymbolinTimeDomain=5.

The foregoing parameters may correspond to Row 5 in Table 7.4.1.5.3-1 in the protocol TS 38.211. In this case, k′[0]=0, k′[1]=1, and l′[0]=0. Based on the calculation method of the foregoing (k̅,l̅), k₀=2f(1)=2·3=6; and l₀=5. Therefore, time-frequency resource locations of four ports are:

$$\begin{matrix}( k , l ) = ( {k}_{0} + {k}^{′} [ 0 ] , {l}_{0} + {l}^{′} [ 0 ] ) , ( {k}_{0} + {k}^{′} [ 1 ] , {l}_{0} + {l}^{′} [ 0 ] ) , ( {k}_{0} + {k}^{′} [ 0 ] , {l}_{0} + 1 + {l}^{′} [ 0 ] ) , ( {k}_{0} + {k}^{′} [ 1 ] , {l}_{0} + 1 + {l}^{′} [ 0 ] ) , \\ = ( 6 + 0 , 5 + 0 ) , ( 6 + 1 , 5 + 0 ) , ( 6 + 0 , 5 + 1 + 0 ) , ( 6 + 1 , 5 + 1 + 0 ) , \\ = ( 6 , 5 ) , ( 7 , 5 ) , ( 6 , 6 ) , ( 7 , 6 )\end{matrix}$$

Based on the foregoing calculation result, a time-frequency resource location shared by one mapping unit of the Costas array 1 marked in FIG. 11b may be determined. It should be noted that the time-frequency resource is multiplexed by four antenna ports.

With reference to Table 7.4.1.5.3-3 in the protocol TS 38.211, it can be learned that a CDM orthogonal code corresponding to the foregoing resource is shown in FIG. 12.

Step c3: Repeat the operation in step c2 to configure all time-frequency locations in a Costas array 1 in the slot on the RB.

Step c4: Implement a periodicity and a related resource offset of a Costas array by configuring a parameter CSI-ResourcePeriodicityAndOffset. This step is the same as that in Example 1, and details are not described herein.

Step c5: Map a sensing resource to an antenna port. Taking FIG. 11a as an example, a mapping relationship may be that a resource (CSI-RS-ResourceSet-1 in FIG. 11a) of a Costas array 1 is mapped to ports 3000 to 3001; a resource (CSI-RS-ResourceSet-2 in FIG. 11a) of a Costas array 2 is mapped to ports 3002 to 3003; a resource (CSI-RS-ResourceSet-3 in FIG. 11a) of a Costas array 3 is mapped to ports 3004 to 3005; and a resource (CSI-RS-ResourceSet-4 in FIG. 11a) of a Costas array 4 is mapped to ports 3006 to 3007. Taking FIG. 11b as an example, a mapping relationship may be that a resource (CSI-RS-ResourceSet-1 in FIG. 11b) of a Costas array 1 is mapped to ports 3000 to 3003; a resource (CSI-RS-ResourceSet-2 in FIG. 11b) of a Costas array 2 is mapped to ports 3004 to 3007; a resource (CSI-RS-ResourceSet-3 in FIG. 11b) of a Costas array 3 is mapped to ports 3008 to 3011; and a resource (CSI-RS-ResourceSet-4 in FIG. 11b) of a Costas array 4 is mapped to ports 3012 to 3015.

It should be noted that in a case that ports use one same Costas array, multi-port Costas signals may be configured by using the signal configuration method provided in any one of Examples 1 to 3. However, this configuration cannot be applied to a multi-node sensing system. Because wireless environments experienced by sensing signals of nodes vary, through only TDM and/or FDM, the signal receive node cannot correctly distinguish sensing signals sent by sensing nodes.

It can be learned from the foregoing that, in the embodiments of this application, the signal transmit node configures the first signal corresponding to each port based on the Costas array corresponding to each of the N ports. Because the Costas array has an ideal thumbtack ambiguity function, the Costas array has excellent autocorrelation performance. When the signal transmit node and the signal receive node perform sensing by using the signal processing method based on matching filtering, signal sensing performance based on the Costas array is optimal on a same time-frequency resource.

In addition, in the embodiments of this application, a group of Costas arrays with an excellent pairwise cross-correlation can be obtained by reasonably selecting or designing Costas arrays. Based on the Costas array, in combination with TDM, FDM, and CDM, first signals corresponding to a plurality of ports (that is, a signal related to a sensing service or a signal related to an integrated sensing and communication service) can be designed to ensure that signals between ports are quasi-orthogonal or orthogonal, so as to ensure multi-port sensing performance. When the signal is applied to multi-node sensing, signal interference between nodes can be relatively small, thereby ensuring performance of multi-node joint sensing.

In addition, in the embodiments of this application, time-frequency resources of ports or nodes can be tightly distributed and even overlapped by using excellent autocorrelation and cross-correlation features of Costas arrays and in combination with OFDM. In this way, sensing resource overheads can be saved, and sensing resource utilization can be improved.

Referring to FIG. 13, FIG. 13 is a flowchart of a signal transmission method according to an embodiment of this application. The method may be executed by a signal receive node. As shown in FIG. 13, the method includes the following steps.

Step 1301: A signal receive node receives, based on a Costas array corresponding to each of N ports of a signal transmit node, a first signal sent by each port, where
the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service.

For example, the signal receive node may determine, based on the Costas array corresponding to each of the N ports of the signal transmit node, a time-frequency resource of the first signal corresponding to each port, and may further receive the first signal corresponding to each port on the determined time-frequency resource of the first signal corresponding to each port.

Optionally, Costas arrays corresponding to the N ports are different;
or
Costas arrays corresponding to M of the N ports are the same, where M is an integer greater than 1 and less than or equal to N.

Optionally, time-frequency resources of Costas arrays corresponding to at least two of the N ports are configured through at least one of time division multiplexing TDM and frequency division multiplexing FDM.

Optionally, in a case that the Costas arrays corresponding to the M of the N ports are the same, time-frequency resources of the Costas arrays corresponding to the M ports are configured through at least one of TDM and FDM, where M is an integer greater than 1 and less than or equal to N.

Optionally, an overlapping part between time-frequency resources of Costas arrays corresponding to different ports is configured through code division multiplexing CDM.

Optionally, a correlation between a Costas array corresponding to a first port and a Costas array corresponding to a second port is less than a preset value, where the first port and the second port are two ports corresponding to different Costas arrays in the N ports.

Optionally, there is an overlapping part between a time-frequency resource of the Costas array corresponding to the first port and a time-frequency resource of the Costas array corresponding to the second port, and the overlapping part is not configured through CDM.

Optionally, a time-frequency resource of a Costas array corresponding to a third port in the N ports and a time-frequency resource of a Costas array corresponding to a fourth port in the N ports are configured through TDM, and the Costas array corresponding to the third port and the Costas array corresponding to the fourth port are different;
and/or
a time-frequency resource of a Costas array corresponding to a fifth port in the N ports and a time-frequency resource of a Costas array corresponding to a sixth port in the N ports are configured through CDM, and the Costas array corresponding to the fifth port and the Costas array corresponding to the sixth port are the same.

Optionally, the method further includes:
receiving, by the signal receive node, at least one resource set identifier from the signal transmit node, where a resource set indicated by each resource set identifier includes a time-frequency resource of a Costas array corresponding to at least one of the N ports;
or
receiving, by the signal receive node, a resource configuration identifier from the signal transmit node, where the resource configuration identifier is used to indicate a first resource configuration, the first resource configuration includes at least one resource set, and each resource set includes a time-frequency resource of a Costas array corresponding to at least one of the N ports.

Optionally, before the receiving, by a signal receive node based on a Costas array corresponding to each of N ports of a signal transmit node, a first signal sent by each port, the method further includes:
receiving, by the signal receive node, first configuration information from the signal transmit node, where the first configuration information is used to configure the first signal corresponding to each of the N ports;
and/or
receiving, by the signal receive node, the first configuration information from a first device, where the first device includes at least one of the following: a sensing function network element, an access and mobility management function network element, and a sensing application server in a core network.

Optionally, the first configuration information includes at least one of the following:
a first configuration parameter, where the first configuration parameter is used to configure the Costas array corresponding to each of the N ports;
a second configuration parameter, where the second configuration parameter is used to configure a time-frequency location of the first signal corresponding to each of the N ports; and
a third configuration parameter, where the third configuration parameter is a port-related configuration parameter.

Optionally, the first configuration parameter includes at least one of the following:
a Costas array type indication, where the Costas array type indication is used to indicate a type of the Costas array corresponding to each of the N ports;
a first prime number set, where the first prime number set includes a prime number used to generate the Costas array corresponding to each of the N ports;
a finite field primitive element set, where the finite field primitive element set includes a finite field primitive element used to generate the Costas array corresponding to each of the N ports; and
a finite field non-zero element set, where the finite field non-zero element set includes a finite field non-zero element used to generate the Costas array corresponding to each of the N ports.

Optionally, the first configuration parameter includes at least one of the following:
an order of the Costas array corresponding to each of the N ports;
an index of the Costas array corresponding to each of the N ports; and
an index of a Costas array set corresponding to each of the N ports.

Optionally, the second configuration parameter includes at least one of the following:
a start frequency of the first signal corresponding to each of the N ports;
a start time of the first signal corresponding to each of the N ports;
a bandwidth of the first signal corresponding to each of the N ports;
duration of the first signal corresponding to each of the N ports;

a first frequency offset corresponding to each of the N ports, where the first frequency offset corresponding to each port is used to indicate an offset of a start frequency of the Costas array corresponding to each port relative to the start frequency of the first signal corresponding to each port;
a first time offset corresponding to each of the N ports, where the first time offset corresponding to each port is used to indicate an offset of a start time of the Costas array corresponding to each port relative to the start time of the first signal corresponding to each port;
a second frequency offset corresponding to each of the N ports, where the second frequency offset corresponding to each port is used to indicate an offset of a start frequency of the Costas array set corresponding to each port relative to the start frequency of the first signal corresponding to each port, and the Costas array set corresponding to each port includes at least one Costas array corresponding to each port;
a second time offset corresponding to each of the N ports, where the second time offset corresponding to each port is used to indicate an offset of a start time of the Costas array set corresponding to each port relative to the start time of the first signal corresponding to each port;
a third frequency offset corresponding to each of the N ports, where the third frequency offset corresponding to each port is used to indicate an offset of the start frequency of the Costas array corresponding to each port relative to a start frequency of a Costas array set to which the Costas array belongs;
a third time offset corresponding to each of the N ports, where the third time offset corresponding to each port is used to indicate an offset of the start time of the Costas array corresponding to each port relative to a start time of a Costas array set to which the Costas array belongs;
a first frequency domain periodicity corresponding to each of the N ports, where the first frequency domain periodicity corresponding to each port is used to indicate a frequency domain interval between Costas array sets corresponding to each port;
a first time domain periodicity corresponding to each of the N ports, where the first time domain periodicity corresponding to each port is used to indicate a time domain interval between Costas array sets corresponding to each port;
a second frequency domain periodicity corresponding to each of the N ports, where the second frequency domain periodicity corresponding to each port is used to indicate a frequency domain interval between Costas arrays in the Costas array set corresponding to each port;
a second time domain periodicity corresponding to each of the N ports, where the second time domain periodicity corresponding to each port is used to indicate a time domain interval between Costas arrays in the Costas array set corresponding to each port;
a first frequency domain repetition coefficient corresponding to each of the N ports, where the first frequency domain repetition coefficient corresponding to each port is used to indicate the number of Costas arrays included in the Costas array set corresponding to each port in frequency domain;
a first time domain repetition coefficient corresponding to each of the N ports, where the first time domain repetition coefficient corresponding to each port is used to indicate the number of Costas arrays included in the Costas array set corresponding to each port in time domain;
a second frequency domain repetition coefficient corresponding to each of the N ports, where the second frequency domain repetition coefficient corresponding to each port is used to indicate the number of Costas array sets corresponding to each port in frequency domain;
a second time domain repetition coefficient corresponding to each of the N ports, where the second time domain repetition coefficient corresponding to each port is used to indicate the number of Costas array sets corresponding to each port in time domain;
a Costas array modulation sequence parameter corresponding to each of the N ports;
a muting pattern corresponding to each of the N ports; and
quasi co-location information of a time-frequency resource in which the Costas array corresponding to each of the N ports is located and another reference signal.

Optionally, the third configuration parameter includes at least one of the following:
a first index, where the first index is used to indicate first information, and the first information includes at least one of the following: a port, a CDM group or a port group, a Costas array or a Costas array set, a multiplexing manner, and a time-frequency location of a Costas array;
information about a CDM group or a port group, where the CDM group or the port group includes at least one port;
a port index allocated to the signal receive node in a CDM group or a port group;
the number of CDM groups or port groups;
the number of ports in a CDM group or a port group;
the number of ports used for transmitting the first signal or the number of ports allocated for sensing measurement;
a minimum port number; and
a maximum port number.

Optionally, the first index includes at least one of the following:
a port index;
a CDM group index or a port group index; and
an index of a Costas array or an index of a Costas array set.

Optionally, the multiplexing manner includes at least one of FDM, TDM, and CDM.

Optionally, before the receiving, by a signal receive node based on a Costas array corresponding to each of N ports of a signal transmit node, a first signal sent by each port, the method includes:
determining, by the signal receive node, the Costas array corresponding to each of the N ports of the signal transmit node.

Optionally, the determining, by the signal receive node, the Costas array corresponding to each of the N ports of the signal transmit node includes:
determining, by the signal receive node, the Costas array corresponding to each of the N ports of the signal transmit node based on a first configuration parameter, where the first configuration parameter includes at least one of the following:
a Costas array type indication, where the Costas array type indication is used to indicate a type of the Costas array corresponding to each of the N ports;
a first prime number set, where the first prime number set includes a prime number used to generate the Costas array corresponding to each of the N ports;
a finite field primitive element set, where the finite field primitive element set includes a finite field primitive element used to generate the Costas array corresponding to each of the N ports; and
a finite field non-zero element set, where the finite field non-zero element set includes a finite field non-zero element used to generate the Costas array corresponding to each of the N ports; or
the first configuration parameter includes at least one of the following:
an order of the Costas array corresponding to each of the N ports;
an index of the Costas array corresponding to each of the N ports; and
an index of a Costas array set corresponding to each of the N ports.

Optionally, the receiving, by a signal receive node based on a Costas array corresponding to each of N ports of a signal transmit node, a first signal sent by each port includes:
receiving, by the signal receive node, the first signal corresponding to each port based on the Costas array corresponding to each of the N ports of the signal transmit node and a configuration parameter of a channel state information reference signal CSI-RS, where the first signal is the CSI-RS.

It should be noted that for an implementation of this embodiment, refer to the related descriptions of the embodiment shown in FIG. 7. Details are not described herein again.

It should be noted that the signal transmission method provided in the embodiments of this application may be executed by a signal transmission apparatus, or a control module that is in the signal transmission apparatus and that is configured to execute the signal transmission method. In the embodiments of this application, an example in which the signal transmission apparatus executes the signal transmission method is used to describe the signal transmission apparatus provided in the embodiments of this application.

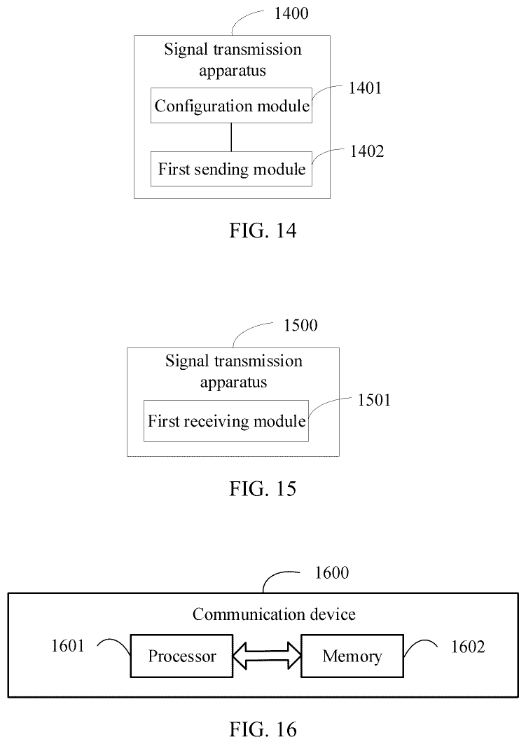

Referring to FIG. 14, FIG. 14 is a structural diagram of a signal transmission apparatus according to an embodiment of this application. The signal transmission apparatus is applied to a signal receive node. As shown in FIG. 14, the signal transmission apparatus 1400 includes:
a configuration module 1401, configured to configure a first signal corresponding to each port based on a Costas array corresponding to each of N ports, where the Costas array corresponding to each port includes at least one Costas array or at least one Costas array set, each Costas array set includes at least one Costas array, Nis an integer greater than 1, and the first signal includes a signal related to a sensing service or a signal related to an integrated sensing and communication service; and
a first sending module 1402, configured to send the first signal corresponding to each port on each port.

Optionally, Costas arrays corresponding to the N ports are different;
or
Costas arrays corresponding to M of the N ports are the same, where M is an integer greater than 1 and less than or equal to N.

Optionally, time-frequency resources of Costas arrays corresponding to at least two of the N ports are configured through at least one of time division multiplexing TDM and frequency division multiplexing FDM.

Optionally, in a case that the Costas arrays corresponding to the M of the N ports are the same, time-frequency resources of the Costas arrays corresponding to the M ports are configured through at least one of TDM and FDM, where M is an integer greater than 1 and less than or equal to N.

Optionally, an overlapping part between time-frequency resources of Costas arrays corresponding to different ports is configured through code division multiplexing CDM.

Optionally, a correlation between a Costas array corresponding to a first port and a Costas array corresponding to a second port is less than a preset value, where the first port and the second port are two ports corresponding to different Costas arrays in the N ports.

Optionally, there is an overlapping part between a time-frequency resource of the Costas array corresponding to the first port and a time-frequency resource of the Costas array corresponding to the second port, and the overlapping part is not configured through CDM.

Optionally, a time-frequency resource of a Costas array corresponding to a third port in the N ports and a time-frequency resource of a Costas array corresponding to a fourth port in the N ports are configured through TDM, and the Costas array corresponding to the third port and the Costas array corresponding to the fourth port are different;
and/or
a time-frequency resource of a Costas array corresponding to a fifth port in the N ports and a time-frequency resource of a Costas array corresponding to a sixth port in the N ports are configured through CDM, and the Costas array corresponding to the fifth port and the Costas array corresponding to the sixth port are the same.

Optionally, the apparatus further includes a second sending module, and the second sending module is configured to:
send at least one resource set identifier to a signal receive node, where a resource set indicated by each resource set identifier includes a time-frequency resource of a Costas array corresponding to at least one of the N ports;
or
send a resource configuration identifier to a signal receive node, where the resource configuration identifier is used to indicate a first resource configuration, the first resource configuration includes at least one resource set, and each resource set includes a time-frequency resource of a Costas array corresponding to at least one of the N ports.

Optionally, the apparatus further includes:
a third sending module, configured to send first configuration information to the signal receive node, where the first configuration information is used to configure the first signal corresponding to each of the N ports;
and/or
a first receiving module, configured to receive the first configuration information.

Optionally, the first configuration information includes at least one of the following:
a first configuration parameter, where the first configuration parameter is used to configure the Costas array corresponding to each of the N ports;
a second configuration parameter, where the second configuration parameter is used to configure a time-frequency location of the first signal corresponding to each of the N ports; and
a third configuration parameter, where the third configuration parameter is a port-related configuration parameter.

Optionally, the first configuration parameter includes at least one of the following:
a Costas array type indication, where the Costas array type indication is used to indicate a type of the Costas array corresponding to each of the N ports;
a first prime number set, where the first prime number set includes a prime number used to generate the Costas array corresponding to each of the N ports;
a finite field primitive element set, where the finite field primitive element set includes a finite field primitive element used to generate the Costas array corresponding to each of the N ports; and
a finite field non-zero element set, where the finite field non-zero element set includes a finite field non-zero element used to generate the Costas array corresponding to each of the N ports.

Optionally, the first configuration parameter includes at least one of the following:
an order of the Costas array corresponding to each of the N ports;
an index of the Costas array corresponding to each of the N ports; and
an index of a Costas array set corresponding to each of the N ports.

Optionally, the second configuration parameter includes at least one of the following:
a start frequency of the first signal corresponding to each of the N ports;
a start time of the first signal corresponding to each of the N ports;
a bandwidth of the first signal corresponding to each of the N ports;
duration of the first signal corresponding to each of the N ports;
a first frequency offset corresponding to each of the N ports, where the first frequency offset corresponding to each port is used to indicate an offset of a start frequency of the Costas array corresponding to each port relative to the start frequency of the first signal corresponding to each port;
a first time offset corresponding to each of the N ports, where the first time offset corresponding to each port is used to indicate an offset of a start time of the Costas array corresponding to each port relative to the start time of the first signal corresponding to each port;
a second frequency offset corresponding to each of the N ports, where the second frequency offset corresponding to each port is used to indicate an offset of a start frequency of the Costas array set corresponding to each port relative to the start frequency of the first signal corresponding to each port, and the Costas array set corresponding to each port includes at least one Costas array corresponding to each port;
a second time offset corresponding to each of the N ports, where the second time offset corresponding to each port is used to indicate an offset of a start time of the Costas array set corresponding to each port relative to the start time of the first signal corresponding to each port;
a third frequency offset corresponding to each of the N ports, where the third frequency offset corresponding to each port is used to indicate an offset of the start frequency of the Costas array corresponding to each port relative to a start frequency of a Costas array set to which the Costas array belongs;
a third time offset corresponding to each of the N ports, where the third time offset corresponding to each port is used to indicate an offset of the start time of the Costas array corresponding to each port relative to a start time of a Costas array set to which the Costas array belongs;
a first frequency domain periodicity corresponding to each of the N ports, where the first frequency domain periodicity corresponding to each port is used to indicate a frequency domain interval between Costas array sets corresponding to each port;
a first time domain periodicity corresponding to each of the N ports, where the first time domain periodicity corresponding to each port is used to indicate a time domain interval between Costas array sets corresponding to each port;
a second frequency domain periodicity corresponding to each of the N ports, where the second frequency domain periodicity corresponding to each port is used to indicate a frequency domain interval between Costas arrays in the Costas array set corresponding to each port;
a second time domain periodicity corresponding to each of the N ports, where the second time domain periodicity corresponding to each port is used to indicate a time domain interval between Costas arrays in the Costas array set corresponding to each port;
a first frequency domain repetition coefficient corresponding to each of the N ports, where the first frequency domain repetition coefficient corresponding to each port is used to indicate the number of Costas arrays included in the Costas array set corresponding to each port in frequency domain;
a first time domain repetition coefficient corresponding to each of the N ports, where the first time domain repetition coefficient corresponding to each port is used to indicate the number of Costas arrays included in the Costas array set corresponding to each port in time domain;
a second frequency domain repetition coefficient corresponding to each of the N ports, where the second frequency domain repetition coefficient corresponding to each port is used to indicate the number of Costas array sets corresponding to each port in frequency domain;
a second time domain repetition coefficient corresponding to each of the N ports, where the second time domain repetition coefficient corresponding to each port is used to indicate the number of Costas array sets corresponding to each port in time domain;
a Costas array modulation sequence parameter corresponding to each of the N ports;
a muting pattern corresponding to each of the N ports; and
quasi co-location information of a time-frequency resource in which the Costas array corresponding to each of the N ports is located and another reference signal.

Optionally, the third configuration parameter includes at least one of the following:
a first index, where the first index is used to indicate first information, and the first information includes at least one of the following: a port, a CDM group or a port group, a Costas array or a Costas array set, a multiplexing manner, and a time-frequency location of a Costas array;
information about a CDM group or a port group, where the CDM group or the port group includes at least one port;
a port index allocated to the signal receive node in a CDM group or a port group;
the number of CDM groups or port groups;
the number of ports in a CDM group or a port group;
the number of ports used for transmitting the first signal or the number of ports allocated for sensing measurement;
a minimum port number; and
a maximum port number.

Optionally, the first index includes at least one of the following:
a port index;
a CDM group index or a port group index; and
an index of a Costas array or an index of a Costas array set.

Optionally, the multiplexing manner includes at least one of FDM, TDM, and CDM.

Optionally, the apparatus includes:
a determining module, configured to: before the first signal corresponding to each port is configured based on the Costas array corresponding to each of the N ports, determine the Costas array corresponding to each of the N ports.

Optionally, the determining module is specifically configured to:
determine the Costas array corresponding to each of the N ports based on first configuration information, where the first configuration information is used to configure the first signal corresponding to each of the N ports.

Optionally, the configuration module is specifically configured to:
configure the first signal corresponding to each port based on the Costas array corresponding to each of the N ports and a configuration parameter of a channel state information reference signal CSI-RS.

The signal transmission apparatus in this embodiment of this application may be an electronic device, for example, an electronic device with an operating system, or may be a component in the electronic device, for example, an integrated circuit or a chip. The electronic device may be a terminal or a network side device, or may be another device other than the terminal or the network side device. For example, the terminal may include but is not limited to the foregoing listed type of the terminal 11, and the network side device may include but is not limited to the foregoing listed type of the network side device 12. The another device may be a server, a network attached storage (Network Attached Storage, NAS), or the like. This is not specifically limited in this embodiment of this application.

The signal transmission apparatus provided in this embodiment of this application can implement the processes implemented in the method embodiment of FIG. 7, and achieve a same technical effect. To avoid repetition, details are not described herein again.

Referring to FIG. 15, FIG. 15 is a structural diagram of a signal transmission apparatus according to an embodiment of this application. The signal transmission apparatus is applied to a signal transmit node. As shown in FIG. 15, the signal transmission apparatus 1500 includes:
a first receiving module 1501, configured to receive, based on a Costas array corresponding to each of N ports of a signal transmit node, a first signal sent by each port, where
the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service.

Optionally, Costas arrays corresponding to the N ports are different;
or
Costas arrays corresponding to M of the N ports are the same, where M is an integer greater than 1 and less than or equal to N.

Optionally, time-frequency resources of Costas arrays corresponding to at least two of the N ports are configured through at least one of time division multiplexing TDM and frequency division multiplexing FDM.

Optionally, in a case that the Costas arrays corresponding to the M of the N ports are the same, time-frequency resources of the Costas arrays corresponding to the M ports are configured through at least one of TDM and FDM, where M is an integer greater than 1 and less than or equal to N.

Optionally, an overlapping part between time-frequency resources of Costas arrays corresponding to different ports is configured through code division multiplexing CDM.

Optionally, a correlation between a Costas array corresponding to a first port and a Costas array corresponding to a second port is less than a preset value, where the first port and the second port are two ports corresponding to different Costas arrays in the N ports.

Optionally, there is an overlapping part between a time-frequency resource of the Costas array corresponding to the first port and a time-frequency resource of the Costas array corresponding to the second port, and the overlapping part is not configured through CDM.

Optionally, a time-frequency resource of a Costas array corresponding to a third port in the N ports and a time-frequency resource of a Costas array corresponding to a fourth port in the N ports are configured through TDM, and the Costas array corresponding to the third port and the Costas array corresponding to the fourth port are different;
and/or
a time-frequency resource of a Costas array corresponding to a fifth port in the N ports and a time-frequency resource of a Costas array corresponding to a sixth port in the N ports are configured through CDM, and the Costas array corresponding to the fifth port and the Costas array corresponding to the sixth port are the same.

Optionally, the apparatus further includes a second receiving module, and the second receiving module is configured to:
receive at least one resource set identifier from the signal transmit node, where a resource set indicated by each resource set identifier includes a time-frequency resource of a Costas array corresponding to at least one of the N ports;
or
receive a resource configuration identifier from the signal transmit node, where the resource configuration identifier is used to indicate a first resource configuration, the first resource configuration includes at least one resource set, and each resource set includes a time-frequency resource of a Costas array corresponding to at least one of the N ports.

Optionally, the apparatus further includes a third receiving module, and the third receiving module is configured to:
receive first configuration information from the signal transmit node, where the first configuration information is used to configure the first signal corresponding to each of the N ports;
and/or
receive the first configuration information from a first device, where the first device includes at least one of the following: a sensing function network element, an access and mobility management function network element, and a sensing application server in a core network.

Optionally, the first configuration information includes at least one of the following:
a first configuration parameter, where the first configuration parameter is used to configure the Costas array corresponding to each of the N ports;
a second configuration parameter, where the second configuration parameter is used to configure a time-frequency location of the first signal corresponding to each of the N ports; and
a third configuration parameter, where the third configuration parameter is a port-related configuration parameter.

Optionally, the first configuration parameter includes at least one of the following:
a Costas array type indication, where the Costas array type indication is used to indicate a type of the Costas array corresponding to each of the N ports;
a first prime number set, where the first prime number set includes a prime number used to generate the Costas array corresponding to each of the N ports;
a finite field primitive element set, where the finite field primitive element set includes a finite field primitive element used to generate the Costas array corresponding to each of the N ports; and
a finite field non-zero element set, where the finite field non-zero element set includes a finite field non-zero element used to generate the Costas array corresponding to each of the N ports.

Optionally, the first configuration parameter includes at least one of the following:
an order of the Costas array corresponding to each of the N ports;
an index of the Costas array corresponding to each of the N ports; and
an index of a Costas array set corresponding to each of the N ports.

Optionally, the second configuration parameter includes at least one of the following:
a start frequency of the first signal corresponding to each of the N ports;
a start time of the first signal corresponding to each of the N ports;
a bandwidth of the first signal corresponding to each of the N ports;
duration of the first signal corresponding to each of the N ports;
a first frequency offset corresponding to each of the N ports, where the first frequency offset corresponding to each port is used to indicate an offset of a start frequency of the Costas array corresponding to each port relative to the start frequency of the first signal corresponding to each port;
a first time offset corresponding to each of the N ports, where the first time offset corresponding to each port is used to indicate an offset of a start time of the Costas array corresponding to each port relative to the start time of the first signal corresponding to each port;
a second frequency offset corresponding to each of the N ports, where the second frequency offset corresponding to each port is used to indicate an offset of a start frequency of the Costas array set corresponding to each port relative to the start frequency of the first signal corresponding to each port, and the Costas array set corresponding to each port includes at least one Costas array corresponding to each port;
a second time offset corresponding to each of the N ports, where the second time offset corresponding to each port is used to indicate an offset of a start time of the Costas array set corresponding to each port relative to the start time of the first signal corresponding to each port;
a third frequency offset corresponding to each of the N ports, where the third frequency offset corresponding to each port is used to indicate an offset of the start frequency of the Costas array corresponding to each port relative to a start frequency of a Costas array set to which the Costas array belongs;
a third time offset corresponding to each of the N ports, where the third time offset corresponding to each port is used to indicate an offset of the start time of the Costas array corresponding to each port relative to a start time of a Costas array set to which the Costas array belongs;
a first frequency domain periodicity corresponding to each of the N ports, where the first frequency domain periodicity corresponding to each port is used to indicate a frequency domain interval between Costas array sets corresponding to each port;
a first time domain periodicity corresponding to each of the N ports, where the first time domain periodicity corresponding to each port is used to indicate a time domain interval between Costas array sets corresponding to each port;
a second frequency domain periodicity corresponding to each of the N ports, where the second frequency domain periodicity corresponding to each port is used to indicate a frequency domain interval between Costas arrays in the Costas array set corresponding to each port;
a second time domain periodicity corresponding to each of the N ports, where the second time domain periodicity corresponding to each port is used to indicate a time domain interval between Costas arrays in the Costas array set corresponding to each port;
a first frequency domain repetition coefficient corresponding to each of the N ports, where the first frequency domain repetition coefficient corresponding to each port is used to indicate the number of Costas arrays included in the Costas array set corresponding to each port in frequency domain;
a first time domain repetition coefficient corresponding to each of the N ports, where the first time domain repetition coefficient corresponding to each port is used to indicate the number of Costas arrays included in the Costas array set corresponding to each port in time domain;
a second frequency domain repetition coefficient corresponding to each of the N ports, where the second frequency domain repetition coefficient corresponding to each port is used to indicate the number of Costas array sets corresponding to each port in frequency domain;
a second time domain repetition coefficient corresponding to each of the N ports, where the second time domain repetition coefficient corresponding to each port is used to indicate the number of Costas array sets corresponding to each port in time domain;
a Costas array modulation sequence parameter corresponding to each of the N ports;
a muting pattern corresponding to each of the N ports; and
quasi co-location information of a time-frequency resource in which the Costas array corresponding to each of the N ports is located and another reference signal.

Optionally, the third configuration parameter includes at least one of the following:
a first index, where the first index is used to indicate first information, and the first information includes at least one of the following: a port, a CDM group or a port group, a Costas array or a Costas array set, a multiplexing manner, and a time-frequency location of a Costas array;
information about a CDM group or a port group, where the CDM group or the port group includes at least one port;
a port index allocated to the signal receive node in a CDM group or a port group;
the number of CDM groups or port groups;
the number of ports in a CDM group or a port group;
the number of ports used for transmitting the first signal or the number of ports allocated for sensing measurement;
a minimum port number; and
a maximum port number.

Optionally, the first index includes at least one of the following:
a port index;
a CDM group index or a port group index; and
an index of a Costas array or an index of a Costas array set.

Optionally, the multiplexing manner includes at least one of FDM, TDM, and CDM.

Optionally, the apparatus includes:
a determining module, configured to: before the first signal sent by each port is received based on the Costas array corresponding to each of the N ports of the signal transmit node, determine the Costas array corresponding to each of the N ports of the signal transmit node.

Optionally, the determining module is specifically configured to:
determine the Costas array corresponding to each of the N ports of the signal transmit node based on first configuration information, where the first configuration information is used to configure the first signal corresponding to each of the N ports.

Optionally, the first receiving module is specifically configured to:
receive the first signal corresponding to each port based on the Costas array corresponding to each of the N ports of the signal transmit node and a configuration parameter of a channel state information reference signal CSI-RS, where the first signal is the CSI-RS.

The signal transmission apparatus in this embodiment of this application may be an electronic device, for example, an electronic device with an operating system, or may be a component in the electronic device, for example, an integrated circuit or a chip. The electronic device may be a terminal or a network side device, or may be another device other than the terminal or the network side device. For example, the terminal may include but is not limited to the foregoing listed type of the terminal 11, and the network side device may include but is not limited to the foregoing listed type of the network side device 12. The another device may be a server, a network attached storage (Network Attached Storage, NAS), or the like. This is not specifically limited in this embodiment of this application.

The signal transmission apparatus provided in this embodiment of this application can implement the processes implemented in the method embodiment of FIG. 13, and achieve a same technical effect. To avoid repetition, details are not described herein again.

Optionally, as shown in FIG. 16, an embodiment of this application further provides a communication device 1600, including a processor 1601 and a memory 1602. The memory 1602 stores a program or an instruction that can be run on the processor 1601. For example, when the communication device 1600 is a signal transmit node, the program or the instruction is executed by the processor 1601 to implement the steps of the foregoing signal transmission method embodiment on the signal transmit node side, and can achieve a same technical effect. When the communication device 1600 is a signal receive node, the program or the instruction is executed by the processor 1601 to implement the steps of the foregoing signal transmission method embodiment on the signal receive node side, and a same technical effect can be achieved. To avoid repetition, details are not described herein again.

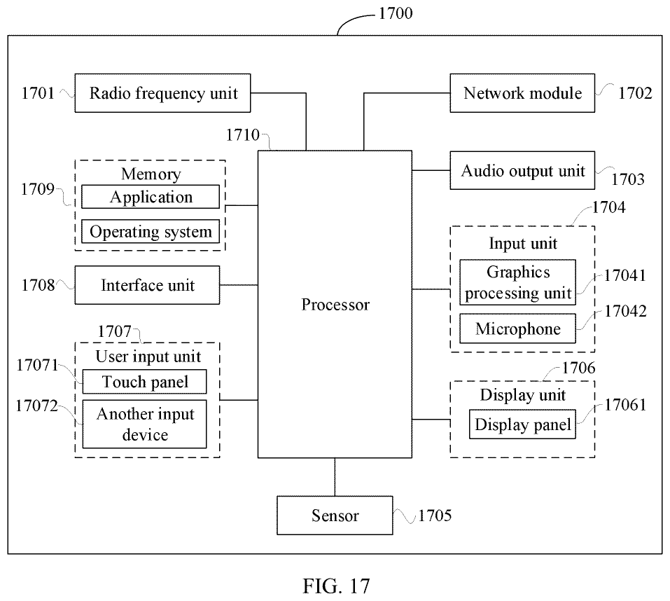

An embodiment of this application further provides a signal transmit node, including a processor and a communication interface. The processor is configured to configure a first signal corresponding to each port based on a Costas array corresponding to each of N ports, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service; and the communication interface is configured to send the first signal corresponding to each port on each port. This signal transmit node embodiment corresponds to the foregoing method embodiment on the signal transmit node side. Each implementation process and implementation of the foregoing method embodiment may be applicable to this signal transmit node embodiment, and a same technical effect can be achieved. Specifically, FIG. 17 is a schematic structural diagram of hardware of a signal transmit node according to an embodiment of this application.

The signal transmit node 1700 includes but is not limited to at least a part of a radio frequency unit 1701, a network module 1702, an audio output unit 1703, an input unit 1704, a sensor 1705, a display unit 1706, a user input unit 1707, an interface unit 1708, a memory 1709, a processor 1710, and the like.

A person skilled in the art may understand that the signal transmit node 1700 may further include a power supply (for example, a battery) that supplies power to each component. The power supply may be logically connected to the processor 1710 by using a power supply management system, so as to manage functions such as charging, discharging, and power consumption by using the power supply management system. The structure of the signal transmit node shown in FIG. 17 does not constitute a limitation on the signal transmit node. The signal transmit node may include more or fewer components than those shown in the figure, or combine some components, or have different component arrangements. Details are not described herein again.

It should be understood that, in this embodiment of this application, the input unit 1704 may include a graphics processing unit (Graphics Processing Unit, GPU) 17041 and a microphone 17042, and the graphics processing unit 17041 processes image data of a still image or a video that is obtained by an image capturing apparatus (for example, a camera) in a video capturing mode or an image capturing mode. The display unit 1706 may include a display panel 17061. The display panel 17061 may be configured in a form such as a liquid crystal display or an organic light-emitting diode. The user input unit 1707 includes at least one of a touch panel 17071 and another input device 17072. The touch panel 17071 is also referred to as a touchscreen. The touch panel 17071 may include two parts: a touch detection apparatus and a touch controller. The another input device 17072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1701 may transmit the downlink data to the processor 1710 for processing. In addition, the radio frequency unit 1701 may send uplink data to the network side device. Usually, the radio frequency unit 1701 includes but is not limited to an antenna, an amplifier, a transceiver, a coupler, a low noise amplifier, a duplexer, and the like.

The memory 1709 may be configured to store a software program or an instruction and various data. The memory 1709 may mainly include a first storage area for storing a program or an instruction and a second storage area for storing data. The first storage area may store an operating system, and an application or an instruction required by at least one function (for example, a sound playing function or an image playing function). In addition, the memory 1709 may be a volatile memory or a non-volatile memory, or the memory 1709 may include a volatile memory and a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1709 in this embodiment of this application includes but is not limited to these memories and a memory of any other proper type.

The processor 1710 may include one or more processing units. Optionally, an application processor and a modem processor are integrated into the processor 1710. The application processor mainly processes an operating system, a user interface, an application, and the like. The modem processor mainly processes a wireless communication signal, for example, a baseband processor. It can be understood that, alternatively, the modem processor may not be integrated into the processor 1710.

The processor 1710 is configured to configure a first signal corresponding to each port based on a Costas array corresponding to each of N ports, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service.

The radio frequency unit 1701 is configured to send the first signal corresponding to each port on each port.

In this embodiment of this application, the signal transmit node configures the first signal corresponding to each port based on the Costas array corresponding to each of the N ports, and sends the first signal corresponding to each port on each port. Because the Costas array has a relatively ideal thumbtack ambiguity function, the first signal corresponding to each port is configured based on the Costas array corresponding to each port, so that anti-interference and resolution of the first signal corresponding to each port can be improved, thereby improving accuracy of multi-port sensing.

It should be noted that all implementation processes and implementations of the foregoing method embodiment may be applicable to the signal transmit node embodiment, and a same technical effect can be achieved.

An embodiment of this application further provides a signal receive node, including a processor and a communication interface. The communication interface is configured to receive, based on a Costas array corresponding to each of N ports of a signal transmit node, a first signal sent by each port, where the Costas array corresponding to each port includes at least one Costas array or at least one Costas array set, each Costas array set includes at least one Costas array, N is an integer greater than 1, and the first signal includes a signal related to a sensing service or a signal related to an integrated sensing and communication service. This signal receive node embodiment corresponds to the foregoing method embodiment on the signal receive node side. Each implementation process and implementation of the foregoing method embodiment may be applicable to this signal receive node embodiment, and a same technical effect can be achieved.

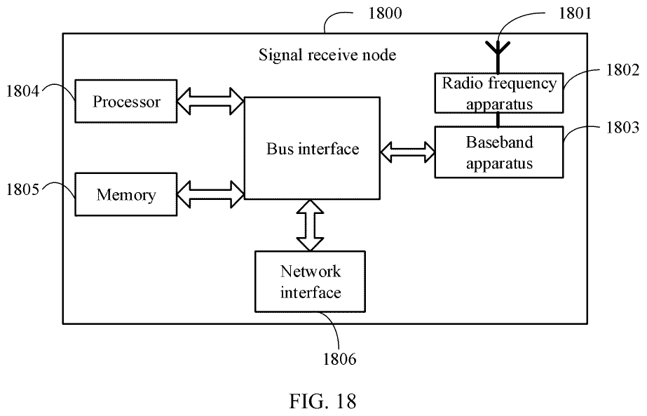

Specifically, an embodiment of this application further provides a signal receive node. As shown in FIG. 18, the signal receive node 1800 includes an antenna 1801, a radio frequency apparatus 1802, a baseband apparatus 1803, a processor 1804, and a memory 1805. The antenna 1801 is connected to the radio frequency apparatus 1802. In an uplink direction, the radio frequency apparatus 1802 receives information by using the antenna 1801, and sends the received information to the baseband apparatus 1803 for processing. In a downlink direction, the baseband apparatus 1803 processes information that needs to be sent, and sends processed information to the radio frequency apparatus 1802. The radio frequency apparatus 1802 processes the received information, and sends processed information by using the antenna 1801.

In the foregoing embodiment, the method executed by the signal receive node may be implemented in the baseband apparatus 1803. The baseband apparatus 1803 includes a baseband processor.

The baseband apparatus 1803 may include, for example, at least one baseband board, where a plurality of chips are disposed on the baseband board. As shown in FIG. 18, one chip is, for example, the baseband processor, is connected to the memory 1805 through a bus interface, to invoke a program in the memory 1805 to perform the operations of the network device shown in the foregoing method embodiment.

The signal receive node may further include a network interface 1806, and the interface is, for example, a common public radio interface (common public radio interface, CPRI).

Specifically, the signal receive node 1800 in this embodiment of this application further includes an instruction or a program that is stored in the memory 1805 and that can be run on the processor 1804. The processor 1804 invokes the instruction or the program in the memory 1805 to execute the method executed by the modules shown in FIG. 15, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing signal transmission method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing signal transmission method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing signal transmission method embodiment, and a same technical effect can be achieved. To avoid repetition, details are not described herein again.

An embodiment of this application further provides a signal transmission system, including a signal transmit node and a signal receive node. The signal transmit node is configured to execute the processes in FIG. 7 and the foregoing method embodiments, and the signal receive node is configured to execute the processes in FIG. 13 and the foregoing method embodiments, and a same technical effect can be achieved. To avoid repetition, details are not described herein again.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A signal transmission method, comprising:
configuring, by a signal transmit node, a first signal corresponding to each port based on a Costas array corresponding to each of N ports, wherein the Costas array corresponding to each port comprises at least one Costas array or at least one Costas array set, each Costas array set comprises at least one Costas array, N is an integer greater than 1, and the first signal comprises a signal related to a sensing service or a signal related to an integrated sensing and communication service; and
sending, by the signal transmit node, the first signal corresponding to each port on each port.

2. The method according to claim 1, wherein Costas arrays corresponding to the N ports are different;
or
Costas arrays corresponding to M of the N ports are the same, wherein M is an integer greater than 1 and less than or equal to N.

3. The method according to claim 1, wherein time-frequency resources of Costas arrays corresponding to at least two of the N ports are configured through at least one of time division multiplexing TDM or frequency division multiplexing FDM.

4. The method according to claim 3, wherein in a case that the Costas arrays corresponding to the M of the N ports are the same, time-frequency resources of the Costas arrays corresponding to the M ports are configured through at least one of TDM or FDM, wherein M is an integer greater than 1 and less than or equal to N.

5. The method according to claim 1, wherein an overlapping part between time-frequency resources of Costas arrays corresponding to different ports is configured through code division multiplexing CDM.

6. The method according to claim 1, wherein a correlation between a Costas array corresponding to a first port and a Costas array corresponding to a second port is less than a preset value, wherein the first port and the second port are two ports corresponding to different Costas arrays in the N ports.

7. The method according to claim 6, wherein there is an overlapping part between a time-frequency resource of the Costas array corresponding to the first port and a time-frequency resource of the Costas array corresponding to the second port, and the overlapping part is not configured through CDM.

8. The method according to claim 1, wherein a time-frequency resource of a Costas array corresponding to a third port in the N ports and a time-frequency resource of a Costas array corresponding to a fourth port in the N ports are configured through TDM, and the Costas array corresponding to the third port and the Costas array corresponding to the fourth port are different;
and/or
a time-frequency resource of a Costas array corresponding to a fifth port in the N ports and a time-frequency resource of a Costas array corresponding to a sixth port in the N ports are configured through CDM, and the Costas array corresponding to the fifth port and the Costas array corresponding to the sixth port are the same.

9. The method according to claim 1, further comprising:
sending, by the signal transmit node, at least one resource set identifier to a signal receive node, wherein a resource set indicated by each resource set identifier comprises a time-frequency resource of a Costas array corresponding to at least one of the N ports;
or
sending, by the signal transmit node, a resource configuration identifier to a signal receive node, wherein the resource configuration identifier is used to indicate a first resource configuration, the first resource configuration comprises at least one resource set, and each resource set comprises a time-frequency resource of a Costas array corresponding to at least one of the N ports.

10. The method according to claim 1, wherein before the configuring, by a signal transmit node, a first signal corresponding to each port based on a Costas array corresponding to each of N ports, the method further comprises:
sending, by the signal transmit node, first configuration information to the signal receive node, wherein the first configuration information is used to configure the first signal corresponding to each of the N ports;
and/or
receiving, by the signal transmit node, the first configuration information,
wherein the first configuration information comprises at least one of the following:
a first configuration parameter, wherein the first configuration parameter is used to configure the Costas array corresponding to each of the N ports;
a second configuration parameter, wherein the second configuration parameter is used to configure a time-frequency location of the first signal corresponding to each of the N ports; or
a third configuration parameter, wherein the third configuration parameter is a port-related configuration parameter.

11. The method according to claim 10, wherein the first configuration parameter comprises at least one of the following:
a Costas array type indication, wherein the Costas array type indication is used to indicate a type of the Costas array corresponding to each of the N ports;
a first prime number set, wherein the first prime number set comprises a prime number used to generate the Costas array corresponding to each of the N ports;
a finite field primitive element set, wherein the finite field primitive element set comprises a finite field primitive element used to generate the Costas array corresponding to each of the N ports; or
a finite field non-zero element set, wherein the finite field non-zero element set comprises a finite field non-zero element used to generate the Costas array corresponding to each of the N ports.

12. The method according to claim 10, wherein the first configuration parameter comprises at least one of the following:
an order of the Costas array corresponding to each of the N ports;
an index of the Costas array corresponding to each of the N ports; or
an index of a Costas array set corresponding to each of the N ports.

13. The method according to claim 10, wherein the second configuration parameter comprises at least one of the following:
a start frequency of the first signal corresponding to each of the N ports;
a start time of the first signal corresponding to each of the N ports;
a bandwidth of the first signal corresponding to each of the N ports;
duration of the first signal corresponding to each of the N ports;
a first frequency offset corresponding to each of the N ports, wherein the first frequency offset corresponding to each port is used to indicate an offset of a start frequency of the Costas array corresponding to each port relative to the start frequency of the first signal corresponding to each port;
a first time offset corresponding to each of the N ports, wherein the first time offset corresponding to each port is used to indicate an offset of a start time of the Costas array corresponding to each port relative to the start time of the first signal corresponding to each port;
a second frequency offset corresponding to each of the N ports, wherein the second frequency offset corresponding to each port is used to indicate an offset of a start frequency of the Costas array set corresponding to each port relative to the start frequency of the first signal corresponding to each port, and the Costas array set corresponding to each port comprises at least one Costas array corresponding to each port;
a second time offset corresponding to each of the N ports, wherein the second time offset corresponding to each port is used to indicate an offset of a start time of the Costas array set corresponding to each port relative to the start time of the first signal corresponding to each port;
a third frequency offset corresponding to each of the N ports, wherein the third frequency offset corresponding to each port is used to indicate an offset of the start frequency of the Costas array corresponding to each port relative to a start frequency of a Costas array set to which the Costas array belongs;
a third time offset corresponding to each of the N ports, wherein the third time offset corresponding to each port is used to indicate an offset of the start time of the Costas array corresponding to each port relative to a start time of a Costas array set to which the Costas array belongs;
a first frequency domain periodicity corresponding to each of the N ports, wherein the first frequency domain periodicity corresponding to each port is used to indicate a frequency domain interval between Costas array sets corresponding to each port;
a first time domain periodicity corresponding to each of the N ports, wherein the first time domain periodicity corresponding to each port is used to indicate a time domain interval between Costas array sets corresponding to each port;
a second frequency domain periodicity corresponding to each of the N ports, wherein the second frequency domain periodicity corresponding to each port is used to indicate a frequency domain interval between Costas arrays in the Costas array set corresponding to each port;
a second time domain periodicity corresponding to each of the N ports, wherein the second time domain periodicity corresponding to each port is used to indicate a time domain interval between Costas arrays in the Costas array set corresponding to each port;
a first frequency domain repetition coefficient corresponding to each of the N ports, wherein the first frequency domain repetition coefficient corresponding to each port is used to indicate the number of Costas arrays comprised in the Costas array set corresponding to each port in frequency domain;
a first time domain repetition coefficient corresponding to each of the N ports, wherein the first time domain repetition coefficient corresponding to each port is used to indicate the number of Costas arrays comprised in the Costas array set corresponding to each port in time domain;
a second frequency domain repetition coefficient corresponding to each of the N ports, wherein the second frequency domain repetition coefficient corresponding to each port is used to indicate the number of Costas array sets corresponding to each port in frequency domain;
a second time domain repetition coefficient corresponding to each of the N ports, wherein the second time domain repetition coefficient corresponding to each port is used to indicate the number of Costas array sets corresponding to each port in time domain;
a Costas array modulation sequence parameter corresponding to each of the N ports;
a muting pattern corresponding to each of the N ports; or
quasi co-location information of a time-frequency resource in which the Costas array corresponding to each of the N ports is located and another reference signal.

14. The method according to claim 10, wherein the third configuration parameter comprises at least one of the following:
a first index, wherein the first index is used to indicate first information, and the first information comprises at least one of the following: a port, a CDM group or a port group, a Costas array or a Costas array set, a multiplexing manner, or a time-frequency location of a Costas array, wherein the multiplexing manner comprises at least one of FDM, TDM, or CDM;
information about a CDM group or a port group, wherein the CDM group or the port group comprises at least one port;
a port index allocated to the signal receive node in a CDM group or a port group;
the number of CDM groups or port groups;
the number of ports in a CDM group or a port group;
the number of ports used for transmitting the first signal or the number of ports allocated for sensing measurement;
a minimum port number; or
a maximum port number,
wherein the first index comprises at least one of the following:
a port index;
a CDM group index or a port group index; or
an index of a Costas array or an index of a Costas array set.

15. A signal transmission method, comprising:
receiving, by a signal receive node based on a Costas array corresponding to each of N ports of a signal transmit node, a first signal sent by each port, wherein
the Costas array corresponding to each port comprises at least one Costas array or at least one Costas array set, each Costas array set comprises at least one Costas array, N is an integer greater than 1, and the first signal comprises a signal related to a sensing service or a signal related to an integrated sensing and communication service.

16. The method according to claim 15, further comprising:
receiving, by the signal receive node, at least one resource set identifier from the signal transmit node, wherein a resource set indicated by each resource set identifier comprises a time-frequency resource of a Costas array corresponding to at least one of the N ports;
or
receiving, by the signal receive node, a resource configuration identifier from the signal transmit node, wherein the resource configuration identifier is used to indicate a first resource configuration, the first resource configuration comprises at least one resource set, and each resource set comprises a time-frequency resource of a Costas array corresponding to at least one of the N ports.

17. The method according to claim 15, wherein before the receiving, by a signal receive node based on a Costas array corresponding to each of N ports of a signal transmit node, a first signal sent by each port, the method further comprises:
receiving, by the signal receive node, first configuration information from the signal transmit node, wherein the first configuration information is used to configure the first signal corresponding to each of the N ports;
and/or
receiving, by the signal receive node, the first configuration information from a first device, wherein the first device comprises at least one of the following: a sensing function network element, an access and mobility management function network element, or a sensing application server in a core network.

18. The method according to claim 15, wherein before the receiving, by a signal receive node based on a Costas array corresponding to each of N ports of a signal transmit node, a first signal sent by each port, the method comprises:
determining, by the signal receive node, the Costas array corresponding to each of the N ports of the signal transmit node,
wherein the determining, by the signal receive node, the Costas array corresponding to each of the N ports of the signal transmit node comprises:
determining, by the signal receive node, the Costas array corresponding to each of the N ports of the signal transmit node based on a first configuration parameter, wherein the first configuration parameter comprises at least one of the following:
a Costas array type indication, wherein the Costas array type indication is used to indicate a type of the Costas array corresponding to each of the N ports;
a first prime number set, wherein the first prime number set comprises a prime number used to generate the Costas array corresponding to each of the N ports;
a finite field primitive element set, wherein the finite field primitive element set comprises a finite field primitive element used to generate the Costas array corresponding to each of the N ports; or
a finite field non-zero element set, wherein the finite field non-zero element set comprises a finite field non-zero element used to generate the Costas array corresponding to each of the N ports; or
the first configuration parameter comprises at least one of the following:
an order of the Costas array corresponding to each of the N ports;
an index of the Costas array corresponding to each of the N ports; or
an index of a Costas array set corresponding to each of the N ports.

19. A signal transmit node, comprising a processor and a memory, wherein the memory stores a program or an instruction that can be run on the processor, and the program or the instruction is executed by the processor to implement a signal transmission method, the signal transmission method comprises:
configuring a first signal corresponding to each port based on a Costas array corresponding to each of N ports, wherein the Costas array corresponding to each port comprises at least one Costas array or at least one Costas array set, each Costas array set comprises at least one Costas array, N is an integer greater than 1, and the first signal comprises a signal related to a sensing service or a signal related to an integrated sensing and communication service; and
sending the first signal corresponding to each port on each port.

20. A signal receive node, comprising a processor and a memory, wherein the memory stores a program or an instruction that can be run on the processor, and the program or the instruction is executed by the processor to implement the steps of the signal transmission method according to claim 15.
